(19) United States
(12) Patent Application Publication
(10) Pub. No.: US 2018/0075409 A1
(43) Pub. Date: Mar. 15, 2018

(54) COMMUNICATION SYSTEM FOR OPERATION AND MANAGEMENT OF WORKFLOWS AND INTEGRATION OF MULTIPLE DEVICES UTILIZING DIFFERENT OPERATING PLATFORMS

(71) Applicant: Dematic Corp., Grand Rapids, MI (US)

(72) Inventors: Robert Kreger, Ada, MI (US); Richard Pringle, II, Grand Rapids, MI (US); Brian Spratke, Grand Rapids, MI (US); Dale Moore, Cedar Springs, MI (US); Eric Bracey, Grand Rapids, MI (US); Nathan Ver Beek, Wyoming, MI (US)

(73) Assignee: Dematic Corp., Grand Rapids, MI (US)

(21) Appl. No.: 15/699,286

(22) Filed: Sep. 8, 2017

Related U.S. Application Data
(60) Provisional application No. 62/385,516, filed on Sep. 9, 2016.
(60) Provisional application No. 62/415,297, filed on Oct. 31, 2016.

(51) Int. Cl. G06Q 10/08

(52) U.S. Cl. CPC G06Q 10/08355; G06Q 10/06; G06Q 10/0838

(57) ABSTRACT

A communication and control system for enabling and controlling communications for execution of one or more tasks, functions, and/or operations within a facility can include devices that utilize disparate operating systems and/or software programs, and engines resident on or accessed by the devices. The engines be can operable to access one or more device-neutral workflows that have a set of instructions for directing performance of a selected one or more of the tasks, functions, and/or operations to be performed at the facility. The engines further can translate and communicate the set of instructions to initiate and cause the devices to carry out the set of instructions thereon and enable the devices to perform or execute the selected tasks, functions, and/or operations at the facility.

### CROSS-REFERENCE TO RELATED APPLICATIONS

This application claims the benefit of U.S. Provisional Patent Application No. 62/385,516 filed Sep. 9, 2016, and U.S. Provisional Patent Application No. 62/415,297 filed Oct. 31, 2016.

### INCORPORATION BY REFERENCE

The disclosures of U.S. Provisional Patent Application No. 62/385,516 filed Sep. 9, 2016, and U.S. Provisional Patent Application No. 62/415,297 filed Oct. 31, 2016, are hereby incorporated by reference as if presented herein in their entireties.

### TECHNICAL FIELD

The present disclosure generally is directed to control of workflows such as for picking, sorting and packaging, shipping and other operations in warehouses, distribution, manufacturing and other facilities. In particular, the present disclosure is directed to a communication system for operation and management of business/facility workflows within such facilities, which communication system enables communication and performance a desired business/facility workflow(s) for the facility utilizing a variety of different automated systems and/or devices, which can be utilize different operating platforms and/or programming languages, to perform the operations, tasks and/or functions required for the business/facility workflow.

### BACKGROUND

Warehouses, manufacturing plants, distribution centers and other, similar facilities are becoming more and more automated to meet demands for greater efficiency and control over production, movement of goods and control of inventory to reduce operating costs. It has become increasingly important for companies to be able to very closely track and monitor products, equipment and other assets within their facilities to increase productivity and efficiency in manufacture, inventorying and movement of goods/products through and out of their facilities. For example, while many larger manufacturing companies and retailers have, for some time, emphasized the need to monitor and actively control inventories of products in order to balance demand with their ability to supply such products, other types of companies, such as FedEx, and UPS and other delivery service companies, as well as large online retailers such as Amazon and CDW, further are looking for ways to manage their intake of packages/parcels and/or products (such as in the case of Amazon or CDW) coming into a facility, and thereafter sort, inventory (where needed), pick, place/package and further track the routing of such packages and/or products through a warehouse or distribution/sorting facility, for shipment to recipients or customers all over the country, including making sure of the for delivery of such packages or products to the requested location and within the specified time.

To help accomplish more efficient workflow management in facilities such as manufacturing, distribution, warehouses, etc., automated devices and technologies have been developed to help manage, monitor and perform the functions and/or tasks required for companies' business workflow(s) at their facility. For example, mobile devices such as laptops, tablets and even cellphones are now commonly used, to enable workers to quickly and easily communicate with a facility or company server to input data and receive instructions. Additionally, bar code scanners and QR scanners, optical character readers or cameras, and/or other small, hand held devices can provide further portability, increased efficiency, and/or ease of use by facility personnel to track, sort, store, pick or package, and/or redirect products or equipment as needed. One problem that has arisen, the increasing use and development of such technology and/or devices is, however, that these devices tend to utilize a variety of different operating platforms. For example, some laptops and tablets can utilize Windows (and/or various versions thereof) operating system/platform, while other devices utilize Apple iOS® or Android® operating systems, which operating systems generally are not very compatible with one another. In addition, other devices such as various scanners or optical readers have been developed by a variety of different companies, which not only have utilized different operating systems and/or programming languages before, but further, as newer and/or different versions or improved/new models and/or devices are developed and introduced, such new models or devices often are incompatible with older versions or generations thereof.

As a result, companies often are faced with a difficult choice as to how to integrate newer technologies or devices into their business or facility workflow management since the company or facility already generally will have a very significant investment in their older devices. In addition, it is often difficult for companies to try to standardize their devices or operating platforms used due to different users/workers having different preferences (i.e. some may prefer Android®, while others prefer Apple iOS® or Windows® operable devices), and also because some devices such as scanners, tablets or other systems/devices needed or used may be manufactured by different companies that simply do not use the same or compatible operating platforms. Thus, companies often have no choice but to create and/or purchase customized or device specific workflow logic, programming, and/or instructions that are specific to each of their different devices and/or automated systems utilized, and when such an automated system or device is updated or new device purchased, new sets of business logic and device specific programming/instructions for each such device or automated system also must be created or updated. This can be very time intensive and costly, both in terms of the cost and time required to create new sets of programming, logic, and/or instructions for each new/upgraded device, but also in terms of testing, and fixing bugs or glitches that may occur. This investment of time and expense further can be multiplied significantly for customers that require use of multiple different devices or automated systems and/or operating platforms.

Accordingly, it can be seen that a need exists for a system or workflow control and management addressing the foregoing and other unrelated problems in the art.

### SUMMARY

Briefly described, in one aspect, the present disclosure is related to a communication and control system for integrating and enabling communication between a series of peripheral devices and a device neutral workflow of a facility for controlling operations of a selected facility, e.g., a warehouse or other suitable facility. The workflow communications system may include/incorporate a variety of devices that can perform the one or more functions or operations at a selected facility. These devices also may operate or run various different platforms or operating systems, e.g., Vocollect®, Windows®, Apple iOS®, Android®, etc. The automated system may also include one or more workflows that can be accessed by the various devices, which workflow(s) can include sets of device neutral or device agnostic business logic or instructions for a series of tasks corresponding to prescribed workflow operations or functions to be performed by various devices or at a selected location. In addition, the various devices will include engines configured, operable and/or designed to access, run, or communicate with the overall workflow(s) and allowing the logic or instructions of the workflow(s) to be carried out on devices with distinct operating systems, e.g., on devices running Windows®, Apple iOS®, Vocollect®, Android®, etc. Therefore, the business logic or instructions of the workflow(s) will be device neutral, with specific sub-workflows being provided as needed, for example, to carry out particular operations or functions by selected devices or at the selected location using one or more peripheral devices that may operate or run various distinct platforms or operating systems. Accordingly, if one or more devices are changed or updated or operations/functions of the workflow(s) are modified or updated, only an engine or engines for the particular changed or affected device(s) may have to be modified, rather than having to create device specific workflow programs and instructions for each of the devices linked by the workflow communication systems and running or operating distinct operating systems or platforms. This also may provide for improved integration of devices running various platforms or operating systems.

In another aspect, this disclosure can be directed to a method for operation of a communications and control system at a selected facility. The method may include integrating and enabling communication between a series of peripheral devices and a device neutral workflow of a facility for controlling operations at selected facility, e.g., a warehouse or other suitable facility by providing devices for carrying out tasks, operations or control of the components/systems at the facility, which devices may operate or run distinct platforms or operating systems. The method also may comprise loading one or more engines onto each of the devices, and the method may include accessing at least one workflow (which may have device-neutral business logic), with these engines to carry out the specific tasks, functions, or operations at the facility. These engines may be configured or operable to allow the device-neutral workflow(s) to run on or communicate with the distinct operating systems/platforms of the various peripheral devices so as to utilize the hardware components thereof.

### BRIEF DESCRIPTION OF THE DRAWINGS

FIG. 1 shows a schematic view of a communications system for integrating and enabling communication between a series of preferred devices and a device neutral workflow of a facility for controlling operations of the facility, according to the principles of the present disclosure.

FIG. 2 shows a flow diagram for the operation of the communications system according to principles of the present disclosure.

FIG. 3A-B show diagrams for messaging with the communications system according to principles of this disclosure.

FIG. 4A is a flow diagram illustrating an example of the work flow communications system according to the principles of the present disclosure.

FIG. 4B is a diagram illustrating the flow of control for the communications system according to principles of this disclosure.

FIG. 5 shows an example facility employing the communications system according to principles of this disclosure.

FIG. 6 shows an example picking station for the facility of FIG. 5.

FIG. 7 shows an example put/pick wall assembly or system for the facility of FIG. 5.

### DETAILED DESCRIPTION

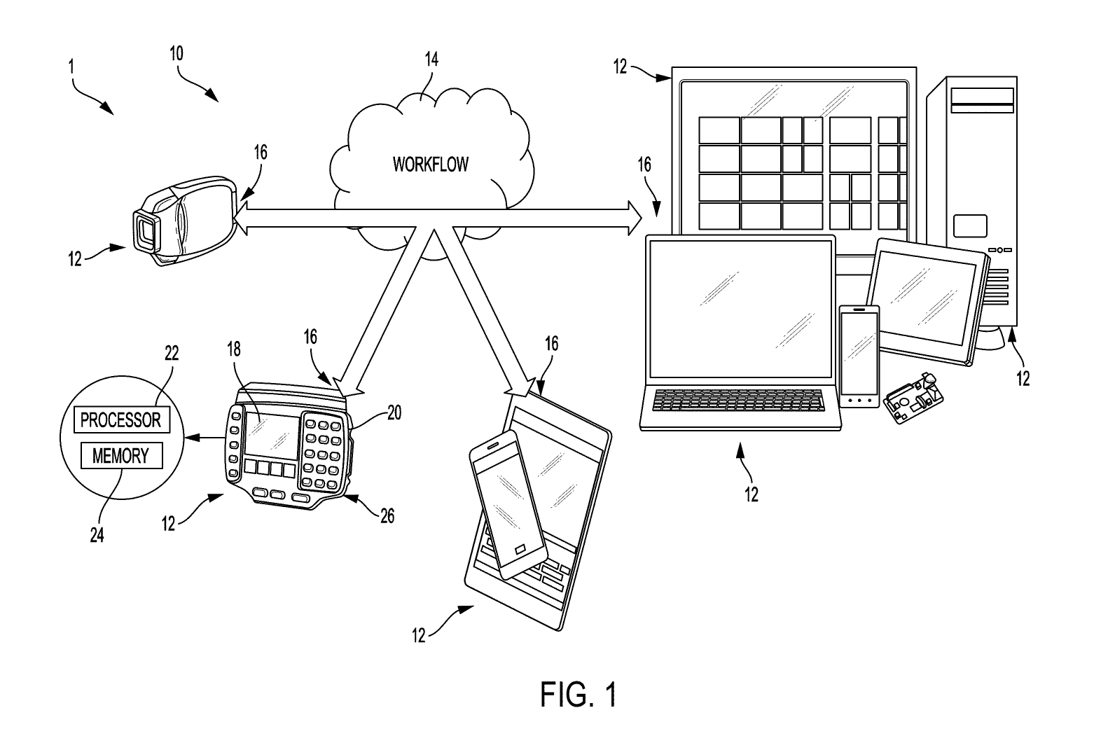

As shown in FIGS. 1-7, this disclosure is directed to a facility 1 having one or more communications systems 10 that control the specific operations or functions at the facility 1. The facility 1 may include various devices 12 for carrying out specific functions or operations at the facility 1, and the communications system 10 may include at least one workflow 14 including instructions for the devices to perform their corresponding functions/operations, as well as one or more engines 16 accessed by, running on, or otherwise in communication with the devices 12, which engines 16 can be configured or operable to communicate with the workflow 14 and initiate and run the workflow 14 on the devices 12. The workflow 14 may be device neutral or independent and can comprise business logic or instructions for performing specific functions or operations of the facility 1 using the various devices 12, while the engines 16 may be device-specific and operable so devices 12 with distinct operating systems or platforms can communicate with and run the at least one workflow 14.

The devices 12 linked to/integrated within the communication system 2 may separately/independently access workflow 14. The workflow 14 generally will contain business logic or instructions for performance of the specific functions/operations of the facility 1. For example, the workflows 14 can be a set of instructions that walks an operator or controls one or more automated systems or devices at the facility 1 through a specific process. The workflows 14 further generally will be device neutral or device independent and can be created and/or written in a selected programming language, without having to be written for or directed to a specific operating platform or software; and can contain primarily the business logic or instructions for performance of the facility's specific functions or operations. For example, the workflow(s) 14 can be written without requiring they contain specific instructions or code for interfacing with each of a series of specific and/or different operating systems of the peripheral devices 12 of the communications system such as to access or operate the functions or hardware of the devices, e.g., specific instructions or logic to access and operate the display 18, inputs 20 or hardware component 26 of the mobile device. In one example, the workflow(s) 14 can be stored in a storage or memory of a server of the automated system 12. The server can include a processor operable to access the memory and carry out the programs or instructions stored therein. The server can be in communication with a network, and the mobile devices also can be in communication with the network allowing the mobile devices 12 to access the workflow(s) 14.

As indicated in FIG. 1, the device neutral or independent overall facility workflow 14 can be created by the facility manager or at an operational facilities control level, and, since it does not have to be device specific, can be focused instead on providing the necessary/desired tasks, functions or other operations required at a particular facility, whether it be a manufacturing plant, a warehouse or distribution center or other, similar type of facility. These instructions or workflow task lists can be created as sub-workflows that also can be easily updated or modified as needed, substantially without regard to the particular device or devices required to perform each of the workflow tasks or functions. For example, a workflow and/or or a series of workflows can be created for different facilities, operations, stations, or for different areas or zones of a plant or facility, such as providing workflow(s) for manufacturing, inventorying, sorting, processing orders, picking and packaging, and/or shipping of products. As noted, the facility workflow 14 can be stored or resident on a server or on a series of servers, including being provided at remote locations or in Cloud storage, and in some embodiments can include a variety of sub-workflows directed to a specific actions, locations and/or types or groups of devices.

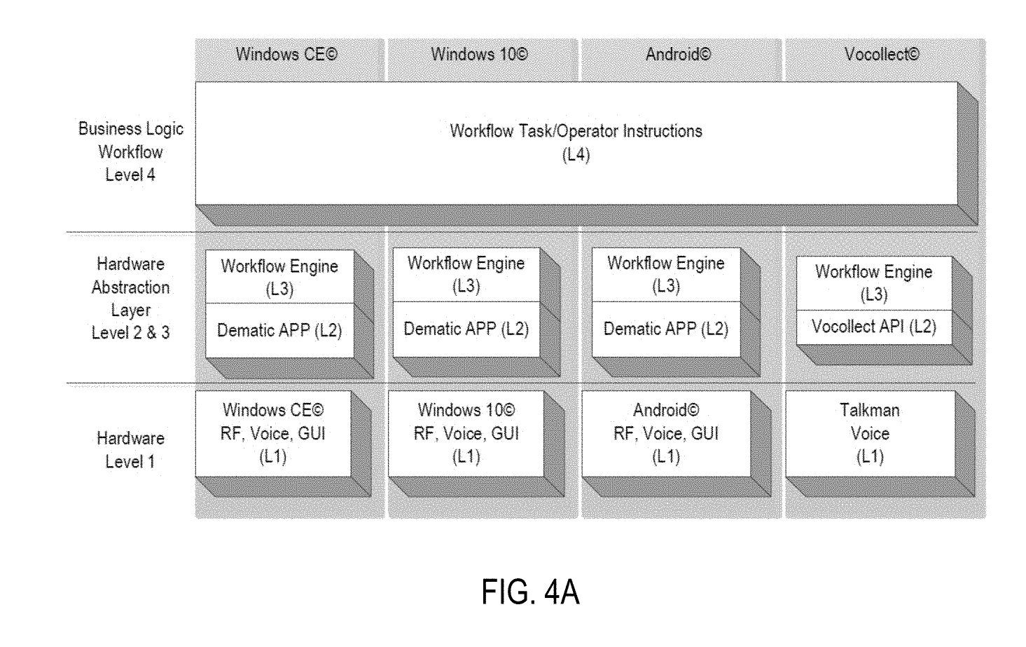

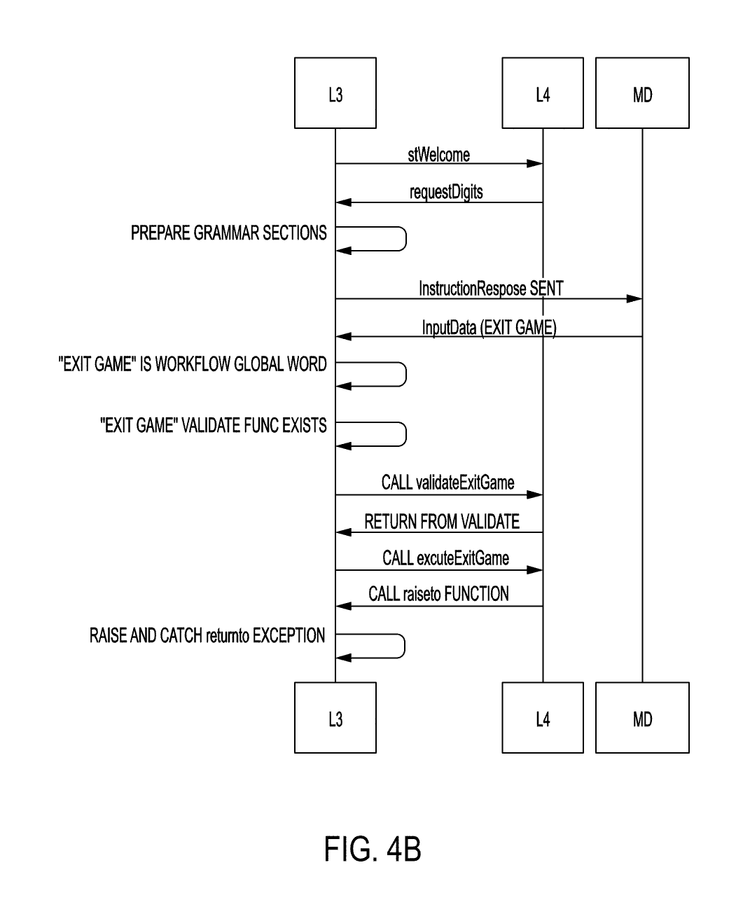

By way of example, a workflow 14 can be designed with task lists or sub-workflows that provide procedures/instructions of a particular facility or customer, for the intake of products or goods coming into the facility; for sorting the incoming products; inventorying the sorted products as needed, including instructions for sending each product or series of products to a known inventory location; procedures/instructions for intake, processing, arrangement and fulfillment of orders in accordance with parameters such as shipping date, type of product, etc.; instructions for retrieving, picking and/or placing goods or products in accordance with each order for packaging; instructions for quality control or review of each order for completeness and to ensure quality; as well as instructions for creating and providing tracking information upon the order or series being discharged from the facility. Each of the sub-workflows or task lists can be retrieved and performed by a variety of different devices, as indicated in FIG. 4A for example, such as the intake and sorting being performed by different types of scanners or optical character readers and cameras. The engines for each of the devices linked as part of the workflow communications system 2 will communicate and access the workflow and can retrieve the instructions for performing each of the required task instructions or steps from the workflow, will interpret these instructions in accordance with the operating platform/language therefor, and thus enable control of their associated devices to perform such functions. The engines further thereafter can communicate back to the workflow or directly to the facility server to indicate that the selected or retrieved task or series of functions has been performed.

Being device neutral, the workflow thus does not have to be concerned with each of the steps or actions undertaken by the individual devices, or which devices in particular were required to perform such a task or workflow function, only that the task was assigned or retrieved to a device and that that task has been completed for a particular product, group of products or order. Thus, in addition to not having to have to recreate or program each separate device with its own workflow instructions, the workflow can be easily and/or readily created, updated and/or otherwise modified as needed and the tasks thereof can be retrieved or assigned to a variety of different devices substantially without regard to differences in programming language or operating platform of the different peripheral devices connected to the workflow by the present communication system 2.

The peripheral devices 12 linked to the workflow 14 as part of the communications system 2 for a facility, or zone thereof, can be configured or operable to perform operations or functions at the facility 1, and can comprise desktops, laptops, mobile phones, tablets, scanners, cameras, optical character recognition readers or other suitable mobile or handheld devices. The devices 12 may operate or run different platforms or operating systems, which can include, for example, Android® platforms, Windows® platforms (e.g., Windows 10® or CE), Vocollect® or any other suitable platforms or operating systems. In one example, the devices may include a processing device 12, such as a laptop, desktop, or a mobile or handheld device, e.g., a tablet or smart phone, with a display 18, one or more inputs 20, a processor 22, a storage or memory 24, and one or more hardware components 26, such as a scanner.

The devices can include, access, or otherwise can be in communication with one or more engines 16 for communication with, interpreting and running of the workflow 14. The engines 16 can be device-specific and contain logic or instructions corresponding to the distinct or different platforms or operating systems of the devices 12. The engines 16 can be stored in the memory 24 of their corresponding devices 12 and may be accessed by the processor 22 of the device 12 to run the workflow(s) 14 thereon. The engines 16 may initiate and run the workflow(s) 14 on the devices 14 so that the device perform the business logic of the workflows and carryout the specific operations and functions at the facility 1. In one example, each engine 16 may comprise a series of components including a first component that can include device-dependent (or device-specific) interface code or instructions operable to manage the corresponding devices 12 resources and other components that may be device-specific, e.g., instructions to access the mobile device's inputs 20 or hardware components 26. The engines 16 may also include a second component that includes device-specific executable logic or instructions operable to start or initiate and communicate with a third component that loads and runs the workflows 14 on the specific device. This component can be referred to as the “workflow device engine” and can comprise a specific code, e.g., Python® code, and the second component can comprise an executable for the specific code, e.g., a Python® executable, operable to start and communicate with Python®, though any suitable type of code or instructions can be used without departing from this disclosure. The workflow engine may contain all the common code that manages connections, e.g., MD or http connections, the workflow state engine, translation and dialogs. The workflow engine and the workflow 14 can communicate with each other through function interfaces. The workflow engine and the second component can communicate through MD or http messages over ports, such as tcp ports or other suitable ports, and the first and second components can communicate through MD/http or other program interfaces.

According to one aspect of this disclosure, an engine or engines 16 can be configured to run/operate on the Universal Windows® Platform (“UWP”), and thus, the workflow(s) 14 can be interpreted and accessed by devices 12 that may run/operate and with UWP. For example, this engine(s) 16 for UWP can allow the workflow(s) 14 to be extended to and accessed by devices 12, including Phones, Tablets, Desktops, Servers, and other suitable devices or information handling systems, operating with Windows® 10 or the UWP family of platforms. For example, the workflow(s) 14 can facilitate interactions with personnel or users at the facility 1 and can use Text-to-Speech (“TTS”) or Automatic Speech Recognition (“ASR”) operations/functions of the devices 12 to perform, or enable workers to perform, various functions or operations at the facility 1. The workflow(s) 14 may also include device neutral logic or instructions that allow facility personnel to interact with a guided user interface provided on the display 13 of the devices 12 to instruct personnel to perform prescribed functions/operations at the facility 1, or to allow personnel to execute specific automated functions or other operations at the facility 1.

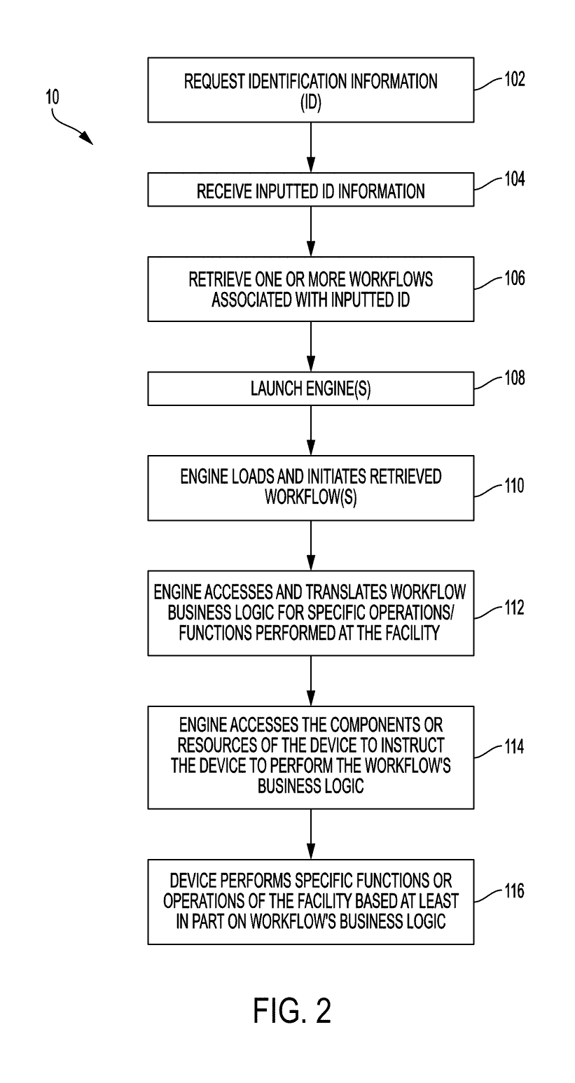

In one example, as shown in FIG. 2, the workflow system 10 may initially request identification information (ID) from the user, operator or worker, e.g., on the display 16 of the mobile device 12 (block 102). The operator/worker can then input an identification information (ID) using the input 20, which can be received by the processor 22 of the mobile device 16 (block 104). The processor 22 can retrieve one or more workflows 14 associated with the operator inputted identification information (ID) (block 106). The processor 22 can then launch or run the engine 16 (block 108) which can load and initiate the retrieved workflows 14 (block 110). The engine 16 can communicate with the retrieved workflows 14 and access and translate the each of the workflows 14 business logic for performance of specific functions or operations at the facility using the mobile device 16 (block 112). Upon reading the business logic, the engine can access the components or resources of the mobile device, e.g., using its operating system or platform, to instruct/control the mobile device to perform/carry out the business logic (block 114). The mobile device 16 may then perform the specific functions or operations at the facility based at least in part on the workflow's business logic (block 116). For example, the workflow(s) 14 may use TTS, ASR, or a guided user interface provided on the display 16 of one or more of the devices 12 to instruct a user to perform, or allow the user to perform, selected functions or operations at the facility 1.

Accordingly, with embodiments of this disclosure, specific workflow(s) 14 for carrying out all, controlling or otherwise facilitating specific operations or functions at the facility can be accessed and run by the engines of each of the devices 12, even if the devices 12 use distinct platforms or operating systems, e.g., one device runs on a Vocollect® platform, one device runs on a Windows® platform, and one device runs on an Android® platform, etc. The workflows 14 can also be accessed by various devices operating with the UWP. Therefore, if/when the workflow(s) 14 is updated or customized, only the workflows 14, themselves, need to be modified rather than individual programs or instructions for each of the devices 12 that use distinct operating platforms. In addition, devices 12 using different platforms or operating systems can be used interchangeably to carry out or perform the functions and operations at the facility. For example, the facility 1 may use a specific number of desktops, e.g., five, running a prescribed workflow 14 to carry out a specific function(s) or operation(s), and this number of desktops may at times not be sufficient to accommodate the needs of the facility, e.g., due to high demand or volume for the specific function performed by the desktops. Rather than needing to buy new desktops to accommodate periods of high demand/volume, with embodiments of this disclosure, the operator of the facility may be able to bring in and used other available devices, e.g., tablets or other mobile devices or information handling systems, to operate the prescribed workflow and meet demand. These devices 12 can each include engines 16 to run the workflow(s) 14 and thus be introduced substantially seamlessly to perform the specific function/operation since a workflow specific to each device operating on a different platform will not have to be developed.

In one aspect, for example, the workflow(s) 14 can include Quality Control workflow(s), which may facilitate analysis of the quality of the functions or operations performed at the facility 1, or allow users or facility personnel to evaluate the quality of operation/functions of the facility 1, and though these Quality Control workflows can be generally performed using devices, such as desktop or a laptop, e.g. operating using the Windows® 10 Platform/operating system or other operating system, during busy periods or times of high demand, using the engines 16 according to this disclosure, the operator of the facility 1 may be able to utilize a tablet or a phone, such as those running Windows 10 mobile, Android or iOS to add additional devices that are less expensive than desktop equipment or available devices, such as users' mobile devices or tablets, to meet operational demands without the need to purchase expensive desktop equipment.

FIG. 4A illustrates a general overview of the design or architecture of the workflow communication system 2 according to one example embodiment or asset. For example, the workflow/communication system may include a series of levels, e.g., four levels. Level 1 (indicated at L1 in FIG. 4A) may be entirely device-dependent and can include interface code, such as code to interface with to manage a device's resources and other items that are device-specific, e.g., Level 1 tablets or hand-held devices (or other hardware) running/operating a platform such as Windows CE®, Windows 10®, Android® or Talkman. Level 2 (indicated at L2 in FIG. 4A) can include an executable, or operating system software, which also may be device-dependent, and/or comprise code needed to start the executable, and communicate with it. Level 3 (indicated at L3 in FIGS. 4A-4B) may include a main code application or work flow engine(s), code that loads, interprets and runs the actual device neutral workflow code, which is Level 4. Level 4 (indicated at L4 in FIGS. 4A-4B) will generally deal with, for example, the configuration, dialogs, translation, messages, global and workflow words, workflow states, and some miscellaneous interfaces like the global cache. The Level 3 code, or “workflow engine,” may contain all the common code that manages connections, the engines, e.g., the workflow state engine, translations and dialogs. Level 3 and 4 may communicate with each other through function interfaces, while Levels 3 and 2 may communicate through messages over one or more ports, e.g., tcp ports and Levels 2 and 1 may communicate through or programmatic interfaces.

The main code, e.g., the Python® code, or other suitable code or programming language can be under a specific directory. The Level 3 code can also be under a directory, while the code for the example EngineTester Level 4 workflow can additionally be under a directory, e.g., an engine tester directory. Under these directories also can be a src directory, and under that may be the directories containing the main code, e.g., the Python® code. The dev and resources directories at the same level as src can be used for test code and resource files (e.g. data files), respectively.

The facility workflow, or sub-work flow thereof, (for example instructions for order Fulfillment) can be a main code, e.g., a Python® code, or other suitable code or programming language that directs the customer through a work process. The engines may carry out this main code on the device so that the customer's interaction between the device and the workflow is substantially seamless. In addition, the Level 3 code can provide an API or base functionality that can handles commonly required function—for example, User Interaction, Communications outside the device, and process flow control. In one example embodiment, a Level 4 or workflow may need:
a package (usually a directory with the name of the workflow under Workflows)
a dev, resources and src directory, under the package directory
a default _init_.py file with no code
a main.py file with the following code: def main( ) WorkflowApp(clMainTask)
a MainTask.py file with a class called clMainTask derived from clWorkflowBase: class clMainTask(clWorkflowBase) the class should contain a stWelcome method which is the starting point of the workflow
a LanguageParsingDirectives.py file that optionally can have info for the grammar utility
a tokens.py file used for tokens that need to be translated
a WorkflowGlobalWords.py file for exit words that are used across all prompts

Level 4 or workflow code may interact with the Level 3 code primarily through the dialogs and states. The dialog methods may allow the Level 4 code to send a prompt to the Level 3 engine and then continues on or waits for a response. EngineTester is an example Level 4 workflow that tries to exercise all the Level 3 workflow capabilities, so it tries different dialog functions, sets flags, etc.

According to one embodiment, a configuration can allow for adaption to the environment without changing code, and allow for establishing communication between device(s) and server(s). There may be multiple configurations, e.g., two files for each workflow. One of the configuration files can be the global workflow file, e.g., workflow.ini, which can be used for all workflows, and another one of the configuration files can be the ini file for the Level 4 workflow, which should have the same name as the workflow, e.g., <workflow>.ini. Properties or external connections specific to the Level 4 workflow can be placed in this second configuration file.

Connections to other systems, such as MD, http or other connections, can be described in the ini files as comm adapters, which can be ini sections where the section name can be Comm.<some unique name>. At a minimum, the comm.default adapter in the global workflow.ini can be configured. This is generally done on various device platforms, e.g., Android® and vPack (which can include Windows10®, Windows CE®, and possibly other Windows® operating software) platforms, when a profile is created using the workflow profile creator in DIT or DiQ. This can put the IP/host name into the global workflow.ini file for that profile, which can typically be downloaded to the device. If other properties of the default adapter need to be manually edited, the workflow.ini can be manually edited. Examples of a default connection in workflow.ini set up may include:

workflow.ini default comm adapter

[comm.default]

Host=127.0.0.1

Port=7342

Filter=1

PT=Voice

PL=

ST=MISSIONCONTROL

SL=SL

MTinMB=True

IsJSON=False

Persistent=True

JSONMTinMB=False

RequestTimeoutlnSeconds=15

; Total of 3 attempts. The initial attempt+2 retries. 3*timeout wait.

; None=retry forever

RequestRetryCount=2

BeepRequestlntervallnSeconds=5

The main code/program, e.g., Python® code, can have one or more modules, e.g., configparser, that can parse ini files and is part of its standard feature set, so that all Level 3 and Level 4 configuration files can use the ini format, an example of which is shown below:

[Section Name1]

Param1=Some value

Param2=Same other value

[Section Name2]

There are several levels of ini files including a global ini file for configuration parameters used by the Level 3 workflow engine, as well as an optional ini file for each Level 4 workflow. The Level 3 workflow ini file can hold information on connections to other processes and workflow defaults. The individual workflow ini files can be used to store values specific to the workflow, for example default values for different variables, string constants or connections to processes that are specific to that workflow.

The Level 3 file can be called ‘workflow.ini’ across all platforms and, in the development environment, may be located at in a workflow resources file. When deployed in an install, a workflow.ini file can be created for each workflow profile that is created. The workflow.ini files can be found at a specific address, e.g., % DC_HOME%\apps\vPack\Configuration\WorkflowProfiles\<name of profile>. If the profiles are changed manually, the modified inis can be added to resources.zip in order for the changes to be loaded onto devices.

When the workflow engine starts, it may look for all the ini files in its directory tree and loads all the properties, including comm adapter properties which will be discussed in more detail below. These properties can be stored in a map, where the key for each property can be in the form ‘<workflow name>.<section name>.<key name>’. For the default properties in workflow.ini, the workflow name can be ‘workflow’. To retrieve them, the getProperty(<key>, aDefault=<default|None>) method may be used, where the first parameter can be the combined section+key, and the second parameter can be the default value if the key is not found in that section. If the key is not found and there is no default, the method can return ‘None’. For example, based on the example above, getting the value of Param2 in Section Name1 can be done/performed with a prescribe call, e.g., getProperty(‘workflow.SectionName1.Param2’, ‘MyDefaultValueIfNotFound’), where a specific value, e.g., ‘MyDefaultValueIfNotFound’, can be returned if the key was not found.

A comm adapter section, e.g., append ‘comm.’ can be specified in front of the name that can be used for the comm adapter. For example, to have a comm adapter called ‘client1,’ the section header in the ini file can be [comm.client1]. The name comm.default can be used to designate the default comm adapter and may be reserved for use in the workflow.ini, which can free a creator of the Level 4 workflows from having to keep track of which comm adapter is being used if they only need one. Additional comm adapters can be specified in the ini file for a particular workflow. It may be possible to have multiple comm adapters for a workflow if all of them have unique names. If duplicate names are assigned, there may be no guarantee as to which set of comm adapter properties will be attached to the name. If there are duplicate comm adapter names in workflow.ini and the Level 4 workflow, the properties in workflow.ini can always be used and the Level 4 configuration can be ignored.

Any comm adapters in workflow.ini can be created at startup, so that communications may be available before choosing a workflow. When a workflow is loaded, its comm adapters can be created and the comm adapters of any other Level 4 workflows can be closed. At any given time, only the adapters from the current workflow and workflow.ini can be active.

There also can be various, e.g., two, three, or more, types of comm adapters that can be set up in the ini files including: MD manager, MD client and web service, and/or others. In one example, embodiment, for an MD connection, only the manager can be used as it can specify what kind of message it is listening for and may be easier to use in general than the client. The client connection can be useful in the case where what the specific MD message type to expect or run into a limitation of the manager implementation is unknown.

The parameters available for various comm adapters can include Common, Manager, Client, and Web Service parameters. For example, the Common parameters, which may be available for both MD manager and client can, for example, include:
Port—the port to connect to
Filter—MD filter to apply to this connection
PT—PT string
PL—PL string
   Example manager parameters can include:
Host—name or ip of host to connect to
SL—SL string
ST—ST string
MTinMB—should mt string be included in the mb (message body) (true/false)
IsJSON—expect messages in json (true/false)
Persistent—socket connection should be persistent (true/false)
JSONMTinMB—if MTinMB is true, should mt be in json (true/false)
   Example client parameters can include:
IP—ip of host to connect to
SendingOnly—only use connection to send messages (true/false)
QueueFileName—name of persistent queue
MaxFilesSize—max size of queue file
NoManager—don't use manager, value doesn't matter, if parameter exists, this will be a client connection
   While example Web Service parameters can include:
the common parameters
Host—name or ip of host to connect to
ConnectionType=Web Service

### Sample MD Manager Connection

### Sample Manager Connection:

[comm.manager1]

### HostName=127.0.0.1

### Port=7339

### Filter=1

### PT=pt

### PL=pl

### ST=st

### SL=sl

IsJSON=false
MTinMB=true
JSONMTinMB=false
Persistent=true

### Sample Web Service Connection

### Sample Web Service Manager Connection:

[comm.webmanager1]

### HostName=127.0.0.1

### Port=7339

### ConnectionType=WebService

With the embodiments of this disclosure, a message can be a Python® class message, whose superclass is the class clMemoryDefinitionBase that can be found in a workflow message file. MD requests generally are handled differently as discussed in more detail below.

Message classes can be used to define the format of the MB portion of the MD message. In the example below, the type field specifies the MT type of the message, MTinMB=True adds the MT type to the MB field and the other fields can describe the content of the MD message.

### MD Message

```
class clWfInit( clMemoryDefinitionBase ):
  MTinMB = True
  type = ‘DEVICECOMMINIT’
  def _init_(self,
  OperatorID=”,
  OperatorName=”,
  TaskFileName=”,
  CustomField=”):
  pass
```

Message classes used in web services also can be derived from clMemoryDefinitionBase. The message class can be used to specify the fields in the message and how the message should be sent. In DiQ, there can be standard RESTful web services and custom, non-standard web services available so when creating the message the initial values for the class should be set appropriately. An example of a standard RESTful web service message definition is shown below:

### RESTful Message

class clRestMessage( clMemoryDefinitionBase ):

type = ‘user/restget’
def_{——}init_{——}(self,
username=‘’,
setname =‘’
):
pass

This message class can contain the minimum amount of information needed to function. The type field tells the main code, e.g., the Python® code, the URI for this web service and the parameters in _init_ can be the fields sent in the message body. The command used can be based on at least in part whether the message is used in a sendMessage or sendRequest call. If sendMessage, it may be assumed that this is a PUT request. If sendRequest, POST can be assumed. If it is a PUT or POST, the message body can be sent as a json string. If the message's http_requesttype field is set to GET, the parameters can be appended to the URI in the form ?param1=value&param2=value. The type field also can be used by MD messages to designate their MD type. Instead of using the type field for the URI, the http_messagetype field could be used. If both are used, http_messagetype may take precedence.

An example of a message with http_requesttype set is shown below:

RESTful Message with Request Type Set

class clRestMessageWithRequestType( clMemoryDefinitionBase ):

type = ‘user/restget’

http_requesttype = ‘GET’

def_{——}init_{——}(self,
username=‘’,
setname =‘’
):
Pass

For a message class with http_requesttype set, both sendMessage and sendRequest requests can use the http_requesttype value as the web service request type, and can override all defaults.

Some PLA apps from DirectorIT can use a non-standard REST type interface. An example of a message that uses the non-standard interface is shown below:

### Non-Standard Message

# Dematic GET call message
class clAccPropertyGet( clMemoryDefinitionBase ):

http_messagetype = ‘property/get’
http_requesttype = ‘GET’
http_format = ‘Dematic’
type = ‘ACCPROPERTYGET’
def_{——}init_{——}(self,
PL=‘’,
PT=‘’,
SeqNum=‘’,
Properties = clMemoryArray((‘Section’,‘’),
(‘Key’,‘’))
):
pass

The difference between a standard message and this example non-standard message can be the http fields. The field http_format can inform the main code, e.g., the Python® code, that the message should be formatted according to a custom standard, which can add the content of the message to the URI, for example, as a JSON string. It may default to ‘REST’. The field http_requesttype can specify what http command to use when sending this message. In this case, the message can always be sent as a GET. For messages with http_format equal to DEMATIC, the default for both sendMessage and sendRequest can use GET. This field can default to ‘AUTO’, which may mean that the Python® Level 3 code can determine what request protocol to use. Finally, the http_messagetype field can hold the URI for the message.

In general, a cross platform methodology enabling communication with resources can be provided to further access work flow and/or business logic requirements as needed. Such a resource can include an external server or other devices, separate from devices, e.g., a scanner, headset or other peripheral device, tethered to a work flow engine device. Messages can be sent to such devices using an instance of the clUMManager class, which contains a comm adapter object. The clUMManager may actually call the send methods of the comm adapter as discussed below. MD messages can be sent using a clMDClient object, which may contain the connection to the MD host/port, while with a manager object, messages can be sent with sendMessage or sendRequest. For sendMessage using an MDManager, the only requirements may be that the message be of type clMemoryDefinitionBase. For sendRequest, the same can be true and the second parameter, a class type (not an object), may also be of the type clMemoryDefinitionBase. If MDClient is used, the send functions can use/request a clMDMessage object. In addition, web service messages can be sent using a clWebManager object, which can serve as the comm adapter for a particular web service. As for MD interfaces, this may usually be contained in an UMManager object, so the particulars of clWebManager can be usually ignored. In a workflow, comm adapters can be set up in the ini file as described herein. Guaranteed messages also may be used/queued. To make a message guaranteed, the comm adapter may have a queue, specified by assigning a name to QueueFileName, as shown in the above example, and the message can have an ID.

When sent, messages can be added to the disk queue and the Level 3 code, which can be Python® code, can keep trying to resend it until it is successful. In general, success can be defined as receiving an acknowledgement when using MD messages. For web services, a success generally can be defined as receiving an http response with a status code of 200 from the server, though there may be some exceptions. For Webservice comm adapters, indirection also can allow comm adapter attributes to be setup out of the box. When a profile is created, the comm adapters in the global worflow.ini can be setup with the actual host and other attributes, but the comm adapters in the individual <workflow name>.ini's may not be set up. To setup the comm adapters for the individual workflows, indirection can allow a comm adapter in an individual workflow.ini to point to one of the comm adapters in the global workflow.ini. The syntax for this indirection can be %[workflowname,comm adapter name, attribute name]%.

Macro replacement can be used for any ini property, not just comm adapters. One example of the syntax for replacement can be %[workflow name, section name, attribute name]%.

Additionally, macros can be configured to point to system environment variables. Environment variables discussed more below. The syntax for an environment variable replacement can be %[env, <environment variable key>]%. If the environment variable is not found, then the value may be None. An example is shown below:

### Sample Webservice Indirection

[comm.Update]

### Host=%[env,ApplicationServerIP]%

### Port=8080

### SendingOnly=True

### MaxFilesSize=500000

### Filter=1

### PT=PT

### PL=PL

### NoManager=True

### ConnectionType=WebService

### BasePath=wcs/resources

The Level 3 workflow also may support environment variables, which can be values that are passed into Level 3 from an external source, e.g., a message from an external system or directly from the Level 2 platform-specific code. The values can be stored in a special map and/or other suitable collection retrieved and set using prescribed functions, for example, the getENV and setENV. Any needed key value pairs can be added to the environment variable collection. In one example, various strings can be used as keys to store values in an Environment Variable dictionary.

Additionally, according to principles of this disclosure, workflow prompts, or dialogs, can be used to pass messages between the user and the workflow. The dialog may prompt the user for some input, either voice or RF, which it passes to the workflow. The workflow can use the input to determine what step to take next and sends the user the next prompt. The workflow engines can handle the communication between the user and workflow so the user seamlessly communicates with the workflow using a specific device, e.g., a tablet, desktop, laptop, etc. Input generally may include non-exit words, which are some type of data (numbers, letters, etc.) that the user enters and exit words, which can be taken from a list passed into the dialog and used to signal that some processing of the non-exit words needs to occur. The difference between the various request dialogs can be that each type of dialog expects a different set of non-exit words, or no non-exit words in the case of requestWords. The different prompts and the options available when using them are discussed further below.

Dialogs can be defined as the interface between the workflow and the user. A dialog can prompts the user for input, which can include to a set of words, numbers, characters or some combination thereof. When the user enters their data, can go to the workflow, which processes it, determines the next step and gives the user the next dialog prompt. There also can be various flags that can be used in a dialog that affect its behavior. These may include options like a zero-length flag, that requires some data be entered if true, and a length flag, that specifies how many characters or digits can be entered, among others. A simple dialog example can include:

import dit_workflow.dialogs
#Getting user input
lNonExitWord, _, _ =
dialogs.requestDigits(aTokenInstruction=clTranslator.TOKEN(aTTS=‘Choose between 0 and
100 and say ready.’,),

aExitWords={“ready”:“Z”})

Before using the prompts, the required modules may be inputted, for example:

# import the prompt functions
from dit_workflow import dialogs
# import the language token functions
from dit_workflow.translate.translator import clTranslator

All request dialogs can share the same parameters, except for requestYesNo. An exemplary set of available parameters is provided below:
aTokenInstruction—a string or clToken object (preferred) that is used as the prompt after translation
aTokenTemp—a string or clToken object (preferred) that is translated and displayed/voiced before the instruction
aExitWords—a map of the local exit words, the map uses the exit word as the key and the value is the set of flags used for the exit word. The available flags are ‘V’ for verify which means that the user must answer ‘Yes’ to a verification question before processing of the exit word can occur; ‘Z’ for zero length which means that a non-exit word must be part of the input; and ‘I’ for include which means that non-exit words are included throughout.
aNonExitWordsEcho—True/False, a flag that determines whether or not non-exit words are echoed when the dialog returns them. Defaults to False.
aScannerEnabled—True/False, a flag that determines whether or not scanner input will be accepted. Defaults to None (equivalent to False)
aLengthToCapture—can be used to tell the workflow how many digits or characters to expect. When that number has been entered, the dialog returns. Defaults to None. If both aLengthToCapture and aAcceptFirstWord (see below) are set, aAcceptFirstWord is ignored.
aDisableGlobalWords—True/False, if True, global workflow words are ignored. Defaults to False.
aDisableWorkflowWords—True/False. As above, except for workflow words.
aDisableSystemWords—True/False. As above, except for system global words.
aAcceptFirstWord—True/False. a flag that determines whether or not the dialog will accept the first valid response uttered. Defaults to False. If an exit word is possible, attach the “I” flag to it in order to return the non-exit word properly when you voice the exit word.
An Accept First Word Example may include:
   1NonExitWord, 1ExitWord, 1IsScanned dialogs.requestDigits(aTokenInstruction=clTranslator.TOKEN(aTTS=‘No Exit Words—Say Digits. Say return to go back to test menu’),
   aDisableGlobalWords=True,
   aExitWords={vcREADY:“IZ”,vcRETURN:“ ”},
   aAcceptFirstWord=True)
aDisableNonExitWords—True/False. This is only valid for the requestWords prompt. Default is True. This is used to discard non-exit words guaranteed. See more details below.

In order for the grammar utility to parse the prompts correctly, each argument (for example, aParts, aTTS, aGUI for the TOKEN; aDisableNonExitWords, etc., for the prompt itself) can be on its own line. Constant tokens should be in the workflow's tokens.py file.

The workflow may prompt user for a yes/no question, such as in a situation where it is desirable to get a user of a device to answer a simple yes or no question, the request Yes/No prompt may not have the aExitWords parameter, since the prompt only say yes or no. The workflow also may prompt the user for input of a number. Here, unlike a yes/no prompt, exit words can be used in a requestDigits prompt, and typically, numbers should be entered as non-exit words. Still further, the workflow may prompt the user for input of a character. This can be the same as the requestDigits prompt, except alpha characters can be entered.

userPrompt = clTranslator.TOKEN(aTTS=“Say a number”,

aParts=None,
aGUI=“Enter a number”)

lNonExitWord, lExitWord, lIsScanned =
dialogs.requestAlpha(aTokenTemp=None,

aTokenInstruction=userPrompt,
aExitWords={“Next”: “”, “Ready”: “I”, “Cancel”:“” },
aNonExitWordsEcho=False
)

The workflow additionally may prompt the user for input of a Float. This can be the same as the requestDigits example, except decimals can also be entered.

userPrompt = clTranslator.TOKEN(aTTS=“Say a number”,

aParts=None,
aGUI=“Enter a number”)

lNonExitWord, lExitWord, lIsScanned =
dialogs.requestFloat(aTokenTemp=None,

aTokenInstruction=userPrompt,
aExitWords={“Next”: “”, “Ready”: “I”, “Cancel”:“” },
aNonExitWordsEcho=False
)

The workflow may prompt the user for an alphanumeric input, which can be the same as the requestDigits, except alpha characters can be entered. For example:

userPrompt = clTranslator.TOKEN(aTTS=“Say a number”,

aParts=None,
aGUI=“Enter a number”)

lNonExitWord, lExitWord, lIsScanned =
dialogs.requestAlphaNumerics(aTokenTemp=None,

aTokenInstruction=userPrompt,
aExitWords={“Next”: “”, “Ready”: “I”, “Cancel”:“” },
aNonExitWordsEcho=False
)

The workflow may prompt the user for input of an exit word only, e.g., only the exit word can be processed. For example:

userPrompt = clTranslator.TOKEN(aTTS=“Say a number”,

aParts=None,
aGUI=“Enter a number”)

lNonExitWord, lExitWord, lIsScanned =
dialogs.requestWords(aTokenTemp=None,

aTokenInstruction=userPrompt,
aExitWords={“Next”: “”, “Ready”: “I”, “Cancel”:“” },
aNonExitWordsEcho=False
)

With this example, non-exit words can be discarded by default, but can be accepted by specifying aDisableNonExitWords=False in the requestWords call. Example below. In this example, it can be possible for the upper level system to send non-exit words with the result and they can be handled by the Level 4 programmer. In 99% of cases this may not be needed, which is why the default can be set to True.

userPrompt = clTranslator.TOKEN(aTTS=“Say a number”,

aParts=None,
aGUI=“Enter a number”)

lNonExitWord, lExitWord, lIsScanned =
dialogs.requestWords(aTokenTemp=None,

aTokenInstruction=userPrompt,
aExitWords={“Next”: “”, “Ready”: “I”, “Cancel”:“” },
aNonExitWordsEcho=False,

aDisableNonExitWords=False

)

The workflow may notify the user to tell the user something without requesting more information. In the case where, e.g., the user is given more information, but a response is not needed, notifyUser can be used. This can put a message into a special message queue. When the next dialog request occurs, all the notification messages can be taken from the queue and displayed/spoken before the prompt for the new dialog request. One code example is:

dialogs.notifyUser(aTokenInstruction=
clTranslator.TOKEN(aTTS=“Hello World”, aParts=
None, aGUI=None, aHelp=None, aIsPriority=True))

The workflow may accept non-exit words. For instance, if the case arises the user is allowed to enter non-exit words without needing to speak an exit word, the AcceptFirstWord functionality may be utilized on any request function. This functionality could be useful in a high-throughput workflow where exit words may not be as useful. Or, for example, a PIN entry prompt can be used. With a prompt like that, the user can be saying the same thing each time they login, thus their error rate may be low and requiring exit words could cause annoyance with repeated use. In this case, AcceptFirstWord could be used to speed up that particular prompt.

Specifying this functionality may be achieved using the aAcceptFirstWord flag set to True. One code example is:

```
dialogs.requestDigits(aTokenInstruction=clTranslator.TOKEN(aTTS=
  ‘Say some digits’ ),
  aExitWords={ “ready” : “IZ” },
  aAcceptFirstWord=True)
```

In this case, the user may be prompted to say digits. Even though “ready” is an exit word, they may not be required to say it to continue. The user can simply say “1 2 3 4”. The workflow will process the digits without speaking ready following a pause. They also can say “1 2 3 4 ready”, the traditional way of interacting.

The ‘Accept First Word’ flag can be set for: requestAlpha, requestDigits, requestAlphaNumerics, and requestFloats.

This functionality may be the same for all request types, but may work slightly differently in the case of a length check. Since length checks can automatically move on once the user says the required number of digits, they may already work similar to the AcceptFirstWord prompts. Therefore in the case of a length check, the AcceptFirstWord option can be effectively ignored.

Additionally, a workflow length check can be set by making the aLengthToCapture flag an integer greater than zero. This can tell the dialog that when the number of non-exit words or the length of the non-exit word equals the flag, the value should be returned and the result processed, without having to utter a non-exit word.

In a voice system, when the user voices a number of characters equal to the length check, the prompt can stop accepting input and processes what has been entered. If the prompt also has an exit word or words, the user can voice an exit words to force processing before the expected number of characters has been entered.

In a Level 4 workflow, the number characters (digits or alpha) that are expected or required from the user at a particular prompt can be specified. Additionally, the prompt could have exit words. In a RF system, all cases where a prompt has a length check can be handled, for example, when the prompt only has a length check, or when the prompt has a length check and exit words.

In the case where there is only a length check, the RF system can set the maximum number of non-exit words allowed in the data entry field to the length check value. Since each individual character may not be processed by the workflow as is done in voice, the user may need a way to tell the system to proceed. So, even though there are no exit words, the GUI could add a “Ready” button as the first button that the user can press to submit the data. If the expected number of characters has not been entered, the GUI may keep the Ready button disabled or display a warning that the user has to enter <length check> characters before continuing. Once the user has entered the required number of characters and pressed ‘Ready,’ a message can be sent with the data entered as the non-exit word and no exit word. The workflow may know that a length check is expected, so it can check the length of the non-exit word and, if it matches the length expected, it can process the message.

In the case where there is a length check and exit words, the RF system can still set the maximum number of characters allowed in the data entry field to the length check value. It also may provide buttons for all the exit words. If there is no ‘Ready’ button, a ‘Ready’ button may be added. If the user presses a valid exit word, a message can be submitted with that exit word and the data entered so far, even if there are fewer characters than the expected length, as the non-exit word. If ‘Ready’ is pressed and there may be no ‘Ready’ in the list of exit words, the system should check the length of the entered data and warn the user if the expected length has not been reached, and can allow the user to continue once the correct length is reached. If the user has chosen a valid exit word (‘Ready’ or not), the workflow may first check whether or not the length of the entered data matches or exceeds the expected length and process it as though there is no exit word if that is the case.

In order for the RF system to know that there is a length check, the Level 3 workflow code can pass that information to it in the VPDISPLAYTEXT message. To do this, a LengthCheck=<length expected>; element may be added to the VPDISPLAYTEXT MsgRule field when there is a length check. When the workflow receives a response, it handles it differently depending on the contents. For example, if the response is a scan, the non-exit word can be processed as is and the length check can be ignored. If the response has no exit word, the non-exit word may be checked for the correct length and processed if it is correct. If it is too short, the response can be rejected and the last prompt will be resent. If it is too long, the response can be truncated to the correct length. If the response has an exit word, the length may not be checked and the message may be processed.

On the RF side, the workflow may be able to parse the VPDISPLAYTEXT message and handle the different scenarios described above. To set the maximum field length, a new input filter can be added to the EditText field. The code for adding a Ready button may be added to the existing exit words code.

The workflow can also prompt user with an image. For example, on any given prompt, the location of an image to display to the user may be included. This location can be determined by the Level 4 workflow and can be a product image, or something else entirely. Currently, the system can support using an URL for the location of the image to display. When the device receives the image location, the device can download and display the image. Below is one example of how to specify the image location.

```
userPrompt = clTranslator.TOKEN(aTTS=“Say a number”,
  aParts=None,
  aGUI=“Enter a number”)
lNonExitWord, lExitWord, lIsScanned =
  dialogs.requestDigits(aTokenTemp=None,
  aTokenInstruction=userPrompt,
  aExitWords={“Next”: “”, “Ready”: “I”, “Cancel”:“” },
  aNonExitWordsEcho=False,
aImageLocation=“http://ecx.images-amazon.com/images/I/
  91Y9h3rM4uL._SL1500_.jpg”)
```

All prompts from the workflow can result in a VPDisplayText message which can be delivered to the Level 2 (Android®, vPack, or other suitable operating system or platform). For displaying images, the MsgData field can be used to send the location payload. This field can be formatted as a JSONObject and other fields in the message can be treated as flat strings. Example messages such as for Android® and vPack are shown below. Various devices and/or device operating systems, however, may not use such message, and may have a UI for displaying images.

### Android®

{“MsgText”: “This is a test of the image display<pause_ms>
100</pause_ms>”, “TTSText”: “This is a test of the image
display<pause_ms>100</pause_ms>”, “MsgRule”:
“GS=vgsREADY;”, “PriorityPrompt”: “False”, “ExitWords”:
“ready”, “NonExitWordsFlag”: “0”, “Command”: “”,
“MsgData”: {“ImageLocation”: “http://ecx.images-amazon.com/
images/I/81OEbr0diBL._SL1500_.jpg”}, “MTinMB”:
“False”}

vPack

VPDISPLAYTEXT\hat{ }This is a test of the image display\hat{ }This is a
test of the image display\hat{ }GS=vgsREADY\hat{ }No\hat{ }ready\hat{ }0\hat{ }
5021\hat{ }{“ImageLocation”:“http://ecx.images-amazon.com/
images/I/81OEbr0diBL._SL1500_.jpg”}

Sending an empty value for ImageLocation can cause the UI on both Android® and vPack to act as if no image was specified. Sending an invalid value for the field can cause the UI's to attempt to retrieve and fail with an error message.

In workflows, translation can be handled by using tokens. A token can be a string that is used as a key to find translations in various languages. By convention, natural language English strings may be used as tokens in workflows. If there are no translations available, the default can be the English token.

One typical method can be to define tokens in a separate file for the workflow in which they appear. By convention, this file can be called tokens.py and include a list of token constants, as the example below demonstrates:
tokens.py

```
from dit_workflow.translate.translator import clTranslator
tokCONFIRM = clTranslator.TOKEN(aTTS=“Goodbye {0}”,
  aIsPriority=False,
  aHelp=“Goodbye Prompt”)
```

This is a typical example showing a few of the options available. First, the token string itself can have a substitution argument ‘{O}’, which, when the token is translated, can be replaced with some variable. Second, the aIsPriority flag can be set to False. This means that a prompt using this token can be interrupted by a subsequent prompt before the TTS has finished voicing it. On the other hand, if the flag were True, the entire prompt must finish before anything else can be voiced. Finally, this prompt can have a help message attached, which can be displayed/voiced if the user inputs ‘Help’.

Below is an example of using the token in a prompt, with the aParts argument set. The parts can be used to replace the substitution argument.

### Using a Token

dialogs.requestYesNo(aTokenIns truction=tokCONFIRM.setParts(‘Fred’)):

The actual translations can be pulled from the messages.txt file for each workflow, which may be built using the actual workflow code and the file. This file initially may be produced by the grammar utility and put in the resources directory for the Level 4 workflow. The utility can find all the tokens and put them into the proper format for each platform for both display (GUI) and voice (TTS). To add translations, the translations file can be edited and checked in.

Workflow can be designed to support multiple “spoken” languages using what is termed “tokenization”. A token is a string that is used as a key to find the string that can be presented to the user. In the main workflow, e.g., the Python® workflow, the default can make tokens natural English strings so that they can be used as the default presentation if no translations are found. Tokens may be pulled from the Level 4 workflow by the grammar utility.

Tokens and their translations may be found in the resources directory for the workflow they belong to in the file <workflow>_Messages.txt. The messages.txt initially can be created by running the grammar utility on the Level 4 workflow, which can make sure that the option to create the messages.txt file can be selected. The grammar utility may parse the main code, e.g., Python® code, and search for clTokens created by the phrase ‘clTranslator.TOKEN’ that it uses to build the WorkflowGrammarUtility_Translations.txt and <workflow>_messages.txt files. The file can be named after the workflow, e.g., EngineTestermessages.txt. The grammar utility can be found in a selected directory, e.g., the $DC_HOME/apps/workflow/bin directory. In the example below, the utility is being asked to create a message file and add lines for the platforms Vocollect, vPack (including Windows10®, Windows CE®, and possibly other Windows® operating software), and Android®.

In the same directory as the workflow grammar utility, a WorkflowGrammarUtility_Translations.txt can be provided, which can have a line for every unique token the utility has found in a workflow. Each line contains the English token, which may be used as the default English translation, and then any other tokens desired, separated by the ‘|’ character. The first line of the file lists the languages supported in the order they may appear on each line, separated by the ‘|’ character. In the example below, note that <spell> and </spell> may not be translated. These may be special tags used by the workflow to designate special handling. The brackets can be substitution characters, which may be replaced at run time with a variable. In this case, whatever the brackets are replaced with can be spelled out, character by character, rather than treated as a complete word or words. Tags and substitutions are discussed in more detail below. Translations can be manually added to the translations.txt file, with each translation separated from the others by the ‘I’ character, as in the first line.

### WorkflowGrammarUtility_Translations.txt

ENU|SPM
<pause>100</pause>Next|
<pause_ms>100</pause_ms>Next|
<spell>uom</spell>|
<spell>{ }</spell> <spell>{ }</spell> put <spell>{ }</spell> { }
{ }|<spell>{ }</spell>
<spell>{ }</spell> poner <spell>{ }</spell> { } { }
<spell>{ }</spell> <spell>{ }</spell> put <spell>{ }</spell>
{ }|<spell>{ }</spell>
<spell>{ }</spell> poner <spell>{ }</spell> { }
<spell>{ }</spell> Hits remaining|Quedan <spell>{ }</spell> resultados
<spell>{ }</spell> Items Left|Quedan <spell>{ }</spell> Artículos
<spell>{ }</spell>put<spell>{ }</spell> { } { }|<spell>{ }</spell>
poner <spell>{ }</spell> { } { }
<spell>{ }</spell> put <spell>{ }</spell> { }|<spell>{ }</spell>
poner <spell>{ }</spell> { }
<spell>{ }</spell> SKU left.|Quedan <spell>{ }</spell>
<spell>sku</spell>.
<spell>{ }</spell> { }|<spell>{ }</spell> { }

The Wf_Messages.txt file can be used to resolve the tokens. The file contains, for each token:
The language specific TTS translation for all platforms selected in the grammar utility for all languages available
The language specific GUI translation for all platforms selected in the grammar utility for all languages available

The actual messages.txt file can contain messages for each of the platform types selected in the grammar utility. Options can include VOCOLLECT, VPACK, ANDROID, WINDOWS, APPLE, etc., each of which can use slightly different syntax to deal with the differences between the ASR engines on each platform. If the platform supports RF (has a display), which may be the case for all platforms except Vocollect, there also can be a <platform name>GUI line. If there is more than one language specified in the WorkflowGrammarUtility_Translations.txt file, there may be a line for each platform for each language. An example list of the comma-separated fields in each line of messages.txt, using the first line above can include:
Counter—17—defines an ascending counter that starts at 1 and continues through the file. This counter is used for debugging.
Token—Enter a new value—defines the token key. By convention, we are using natural language English as keys.
Translation—Enter a new value—defines the token translation which is resolved from the file, this is what will be presented to the user.
Unused field—7—this is a constant, carried over from an earlier version of vPack.
Platform—VPACK—defines the platform and presentation method for each line.
Language—ENU—indicates the language using the standard 3 digit language code. Some of the more common codes seen in Director IT 7 are ENU for English, SPM for Spanish, GER for German
Priority—YES—indicates if the TTS is a priority prompt. NO means that the prompt can be interrupted, YES means the prompt will be spoken to completion.
Unused field
Unused field
Help—Goodbye Prompt.—indicates the help text that will be voiced and displayed when the user asks for help.

In the main code, e.g., the Python® code, a token can be a clToken object used in a dialog request method.

For a clToken object, the following fields may be available:
aTTS—the text to be spoken, REQUIRED
aIsPriority—True/False, must the whole text be spoken before starting on another utterance, REQUIRED. In Android® and vocollect, ASR is disabled until all the text has been voiced.
aParts—for tokens with substitution values ({ }), these parts will be placed in the token at the appropriate positions, defaults to None.
aGUI—the text to be displayed on the device's screen, defaults to empty, in which case the aTTS will be used
aHelp—the text to be displayed and spoken when the user asks for help at this prompt. In vocollect, you have to say ‘talkman help’, rather than just ‘help’.

The grammar utility may pull information from the clToken fields when creating the messages.txt file. The example code snippet below shows a token definition and a sample usage of the requestWords function using that token:
Using a token

tokWELCOME = clTranslator.TOKEN(aTTS=“Welcome to the
Workflow Engine Tester. Say Ready to start.”,

aIsPriority=False)

dialogs.requestWords(aTokenInstruction=tokWELCOME,

aExitWords={“ready”:“”}, aDisableGlobalWords=True,
aDisableWorkflowWords=True)

An additional way to use tokens may be to create the clToken object inside the prompt, using the TOKEN method:
Token object created in prompt

lNonExitWord, _, _ =
dialogs.requestDigits(aTokenInstruction=clTranslator.TOKEN(aTTS=‘Choose between 0 and{ }
and say ready.’,

aGUI=“Choose between 0 and { } and say ready. States are:{ }”,
aParts=[len(self[‘States’]) − 1, self[‘StatesString’]],
aHelp=self[‘StatesList’]),
aExitWords= {“ready”:“Z”},
aDisableGlobalWords=True,
aDisableWorkflowWords=True)

Many times there can be some value or string that is desired to be included in the translated token but it only may be known at run time. Argument substitution can include using some standard marker, usually { }, to designate where the value needs to be inserted. When the token is translated, any arguments can be passed to insert as a list using the aParts parameter, as shown in the example above. The markers may be part of the token.

Tokens are generally expected to use the standard main code, e.g., the Python® code, argument substitution syntax. This can use the { } characters to designate a substitution. For more than one substitution, a pair of brackets can be placed at each position you want the substitution to occur. When the substitution occurs, the list of parts can be inserted in place of the brackets from first to last. To have parts entered in some other order, numeric positions can be assigned to the substitution markers by putting a number inside the brackets, e.g., (0) or (1).

So, for tokens—‘this is the first argument { }. here is the second { }’ and parts—‘first’ and ‘second’—the string after replacement could be: ‘this is the first argument first. here is the second second.’ If the token were changed to: ‘this is the first argument {1}. here is the second {0}’, after replacement you may get: ‘this is the first argument second. here is the second first.’

When the grammar utility creates messages.txt, it can provide the translation for the token, pulling it from the WorkflowGrammarUtility_Translations.txt if it's available. In the messages.txt file, when the utility creates each line, it can translate the substitution markers to the format expected for the platform the line is for. Currently, most platforms, including all GUI values, can use the same syntax as the main code, e.g., Python® syntax, as expected in the tokens. The exception can be vPack, which replaces { } with %R% and starts its numbering from one rather than zero.

In certain cases, it may be desirable to have the TTS handle parts of the token differently than the display. For these cases, tags, similar to HTML tags can be used to specify which parts of the message should be handled differently and what the difference is. The tags can be used for the TTS lines in the messages.txt file and not for the GUI lines.

For example, the following tags can be used in the token:
<spell>#</spell>—tells the TTS engine to spell the replacement string letter by letter in the user's chosen language
<phonetic>#</phonetic>—tells the TTS engine to spell the replacement string phonetic letter by phonetic letter in the user's chosen language. In English, for example, a would be voiced as alpha, b as beta, etc.
<pause_ms>300</pause_ms>—tells the TTS engine to pause for the number of milliseconds specified

When creating a translation, some platforms, such as vPack, may use a different format for the tags, as shown below:

| | Vocollect | | Android ® | |
|---|---|---|---|---|
| Token String | Translation | vPack Translation | Translation | Notes |
| <spell>#</spell> | <spell>#</spell> | \tn=spell\%R%\tn=normal\ | <spell>#</spell> | voices |
| <phonetic>#</phonetic> | <phonetic>#</phonetic> | %S#% | <phonetic>#</phonetic> | ‘a’,‘b’,‘c’,etc. |
| <pause_ms>#</pause_ms> | ,,,,,,,,,,,,, | \Pause=100\ | <pause_ms>#</pause_ms> | |

TTS tags

118,Goodbye <spell>{ }</spell>,Goodbye
\tn=spell\%R%\tn=normal\,7,VPACK,ENU,,,YES,Goodbye Prompt
119,Goodbye <spell>{ }</spell>,Goodbye
<spell>{ }</spell>,7,VOCOLLECT,ENU,,,YES,Goodbye Prompt
120,Goodbye <spell>{ }</spell>,Goodbye <spell>{ }</spell>,7,ANDROID,ENU,,,YES,Goodbye
Prompt
363,Verify {0} <phonetic>{1}</phonetic>,Verify %R1% %S2%,7,VPACK,ENU,,,NO,Say yes
if correct\Pause=100\ otherwise say no.
364, Verify {0} <phonetic>{1}</phonetic>, Verify {0}
<phonetic>{1}</phonetic>,7,VOCOLLECT,ENU,,,NO,Say yes if
correct<pause_ms>100</pause_ms> otherwise say no.
365,Verify {0} <phonetic>{1}</phonetic>, Verify {0}
<phonetic>{1}</phonetic>,7,ANDROID,ENU,,,NO,Say yes if
correct<pause_ms>100</pause_ms> otherwise say no.
356,Verify {0},Verify %R1%,7,VPACK,ENU,,,NO,Say yes if correct\Pause=100\ otherwise say
no.
357,Verify {0},Verify {0},7,VOCOLLECT,ENU,,,NO,Say yes if
correct<pause_ms>100</pause_ms> otherwise say no.
358,Verify {0},Verify {0},7,ANDROID,ENU,,,NO,Say yes if
correct<pause_ms>100</pause_ms> otherwise say no.

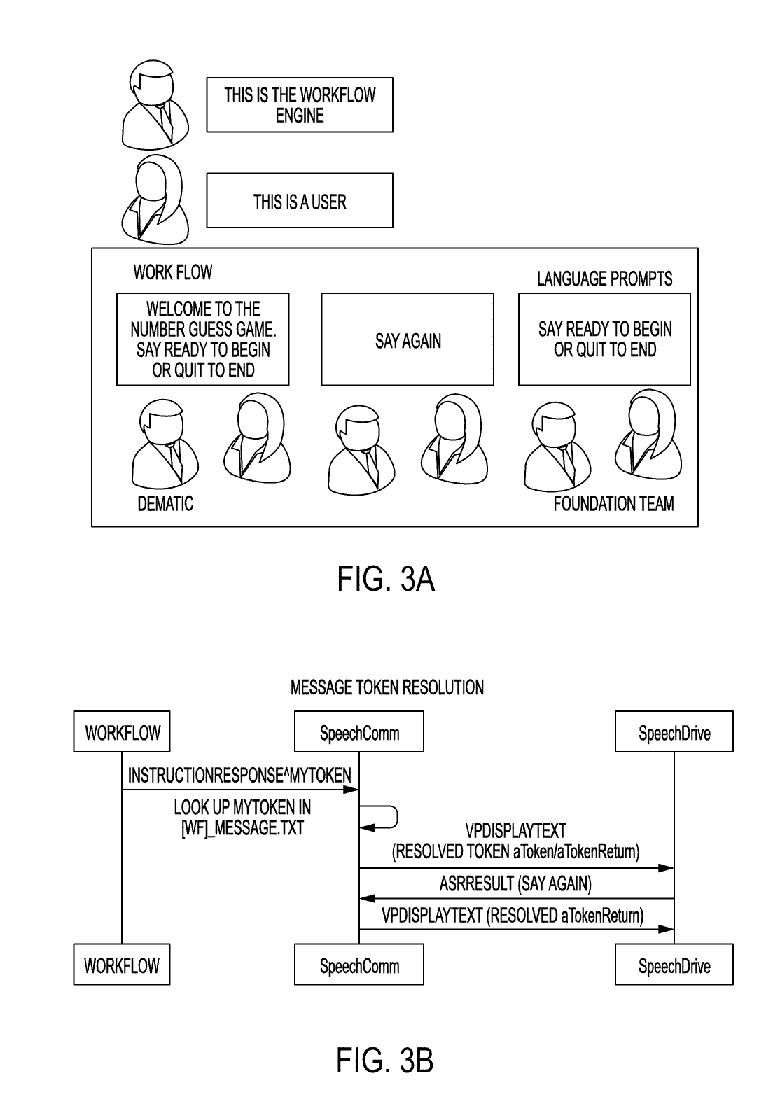

FIG. 3A shows how a conversation may go from a user's perspective, while FIG. 3B shows the conversation may go from a computer messaging perspective on the vPack platform. Other platforms or operating systems may have a similar flow.

Translations can be found by using tokens, which may be part of the key to a map containing the actual translations. Tokens can be found in the Level 4 code as clToken objects created by using the clTranslator.TOKEN method. When the grammar utility runs, it can default the English translation to the token, though it may add to the translation any changes that need to be made to accommodate what the particular platform expects for substitutions and tags. To alter the English version of the token, the token inside the main code, e.g., Python® code, can be changed then grammar utility also can be changed. Any translations of the token into other languages to be added to the WorkflowGrammarUtility_Translations.txt file. After adding them, the grammar utility can be rerun to create a new messages file that includes the new translations.

When the workflow actually runs and a token is encountered in a dialog, the dialog may first translate the token by looking up the token in the messages file, using three keys: the actual token, the platform the workflow is running on (Android®, vPack, or Vocollect®, or other suitable platform or operating system) and the current language (ENU, SPM, etc.). After the translated text is found, the substitution tags can be replaced with actual values or empty strings if no values are passed in. The final string, translated and complete with substitutions, can then be passed to the device to be displayed or spoken. If on a platform (Android® and vPack) where both TTS and a display are available, both the TTS and GUI tokens can be translated and passed to the device.

In the Level 4 code, the grammar utility may generally find tokens created using the clTranslator.TOKEN method. Anything else may not be translatable. A few examples of proper level syntax are included below.

Here is an example of a request method with multiple tokens created inside it. Each of these tokens would end up in the messages.txt file.

lNonExitWord, lExitWord, lIsScanned = dialogs.requestWords
(aTokenTemp=clTranslator.TOKEN(aTTS=“Hello Welcome to the
number guess game”,
aParts=None, aGUI=“Welcome to the Number Guess Game GUI”),

aTokenInstruction=clTranslator.TOKEN(aTTS=“Say Ready
to begin or quit to end”,
aParts=None,
aGUI=“Say Ready or pres the OK button to begin”
aHelp=“The system will think of a number between 0 and 9 and
you have to guess it”)),
aExitWords={“Ready”:“”,“Quit”:“V”},
aNonExitWords=False,
aMDConnection=self._myMDConnection)

Here is another example with multiple tokens. This time they are defined outside the request.

greeting = clTranslator.TOKEN(aTTS=“Welcome to the number
guess game”,

aParts=None,
aGUI=“Welcome to the Number Guess Game GUI”)

userDirection = clTranslator.TOKEN(aTTS=“Say Ready to
begin or quit to end”,

aParts=None,
aGUI=“Say Ready or pres the OK button to begin”
aHelp=“The system will think of a number between 0 and 9
and you have to guess it”)

lNonExitWord, lExitWord, lIsScanned =
dialogs.requestWords(aTokenTemp=greeting,

aTokenInstruction=userDirection,
aExitWords={“Ready”:“”,“Quit”:“V”},
aNonExitWords=False,
aMDConnection=self._myMDConnection)

Using the request method from above may result in the following lines being generated in the <WorkflowName>_Messages.txt file.

17,Welcome to the number guess game,Welcome to the number guess
game,7,VPACK,ENU,,,No,
18,Welcome to the number guess game,Welcome to the Number Guess Game

### GUI,7,VPACKGUI,ENU,,,No,

19,Say Ready to begin or quit to end,Say Ready to begin or quit to end,7,VPACK,ENU,,,No,
20,Say Ready to begin or quit to end,Say Ready or pres the OK button to
begin,7,VPACKGUI,ENU,,,No,

The parser can be fairly advanced and can detect and handle various coding styles, for example:

# Style 1 - multiline TOKEN inside of a request
# OK
lNonExitWord, lExitWord, lIsScanned =
dialogs.requestWords(aTokenTemp=clTranslator.TOKEN(aTTS=“Hello
and welcome to the
number guess game”,

aTokenInstruction=clTranslator.TOKEN(aTTS=“Say Ready to
begin or quit to end”,

aGUI=“Say Ready or pres the OK button to begin”),

aHelpToken=“The system will think of a number between 0 and 9
and you have to guess it”,
aExitWords={“Ready”:“”,“Quit”:“V”},
aNonExitWords=False,
aMDConnection=self._myMDConnection)

# Style 2 - single line TOKEN inside of a request
# OK
lNonExitWord, lExitWord, lIsScanned
dialogs.requestWords(aTokenTemp=clTranslator.TOKEN(aTTS=“Hello
and wWelcome to the number guess game”, aGUI=“ Welcome to the
Number Guess Game GUI”),

aTokenInstruction=clTranslator.TOKEN(aTTS=“Say Ready to
begin or quit to end”,

aGUI=“Say Ready or pres the OK button to begin”),

aHelpToken=“The system will think of a number between 0 and 9
and you have to guess it”,
aExitWords={“Ready”:“”,“Quit”:“V”},
aNonExitWords=False,
aMDConnection=self._myMDConnection)

# Style 3 - multiline token outside a request and with an embedded
comma. Commas are not allowed within the text.
# The parser will raise an error during compilation
# NOT ALLOWED
myTokenVar1 = clTranslator.TOKEN(aTTS=“Welcome to the number
guess game, {0}”,

aParts=“Fred”,

aGUI=“Welcome to the Number Guess Game GUI”)

# Style 4 - multiline token, outside a request with two parameters on the
same line and the ending ) with leading spaces
# OK
myTokenVar2 = clTranslator.TOKEN(aTTS=“Welcome to the number
guess game
<spell>{0}</spell>”,
aParts=“Fred” aGUI=“Welcome to the Number Guess Game GUI”, )
# Style 5 - single line token with an embedded ( and ) to mess up the
parsing
# OK
myTokenVar3 = clTranslator.TOKEN(aTTS=“Welcome to the number
guess (game)”,
aGUI=“Welcome to the Number Guess Game GUI”)
# Style 6 - single quotes and double quotes mixed with embedded ( )
and a comma
# OK
myTokenVar3 = clTranslator.TOKEN(aTTS=‘Welcome to the number
guess (game)’,
aGUI=“Welcome to the Number Guess Game. GUI”)
# Style 7 - embedded = sign
# OK
myTokenVar3 = clTranslator.TOKEN(aTTS=‘Welcome to the number
guess (game)’,
aGUI=“Game = Number Guess Game”)
# Style 8 - mix single and double quotes
# OK
myTokenVar3 = clTranslator.TOKEN(aTTS=“Welcome to the
‘number’ guess game”,
aGUI=“Game = Number Guess Game”)
# Style 9 - mix single and double quotes sample 1
# OK
myTokenVar3 = clTranslator.TOKEN(aTTS=“Welcome to the
‘number’ guess game”,
aGUI=“Game = Number Guess Game”)
# Style 10 - mix single and double quotes sample 2
# OK
myTokenVar3 = clTranslator.TOKEN(aTTS=‘Welcome to the
“number” guess game’,
aGUI=“Game = Number Guess Game”)
# Style 11 - non-matching single quote nested within double quotes
# OK
myTokenVar3 = clTranslator.TOKEN(aTTS=“The conveyor is 10′ long”,
aGUI=“Game = Number Guess Game”)
# Style 12 - non-matching double quote nested within singe quotes
# OK
myTokenVar3 = clTranslator.TOKEN(aTTS=“The conveyor is 144″
long”, aGUI=“Game = Number Guess Game”)
# Style 13 - non-matching right parenthesis
# OK
myTokenVar3 = clTranslator.TOKEN(aTTS=“Say hello with a smiley :)”,
aGUI=“Game = Number Guess Game”)
# Style 14 - non-matching left parenthesis
# OK
myTokenVar3 = clTranslator.TOKEN(aTTS=“Do not be sad :(”,
aGUI=“Game = Number Guess Game”)
# Style 15 - invalid replacement arguments - sample 1
# NOT ALLOWED. { } must either have a numeric value or no value.
myTokenVar3 = clTranslator.TOKEN(aTTS=“The user had to wait
{minutes} before continuing”, aGUI=“Game = Number Guess Game”)
# Style 16 - invalid replacement arguments
# NOT ALLOWED. { } cannot have extra spaces. This is not even
allowed in Python
myTokenVar3 = clTranslator.TOKEN(aTTS=“The user had to wait { 0 }
before continuing”,
aGUI=“Game = Number Guess Game”)

The parser may search a specific aspect or feature, for example, for the last “)”, to mark the end of the statement. The ending “)” is the last “)” that is not contained within quotes. The quotes can be single or double, but generally should match.

Next, the parser may identify various input parameters, which in one embodiment can include:
aTTS
aParts
aGUI

The parser can handle various characters and/or values, such as “(”, “)”, “=”, and commas within the string, or combinations thereof.

The parser can issue a warning during the compilation if a Translate.TOKEN contains statement contains arguments that are set without single or double quotes. This can mean that the language value is being set via a variable and it might be an issue.

To disable the warnings, an argument can be to the TOKEN method called aSuppressWarnings=True. Here is an example:

# Style 6—single quotes and double quotes mixed with embedded ( ) and a comma myTokenVar3=clTranslator.TOKEN(aTTS=‘Welcome to the number guess (game)’, aGUI=“Welcome to the Number Guess Game. GUI” aSuppressWarnings=True)

Additionally, with embodiments of this disclosure, messages can be used to communicate back and forth with external systems, and for example Execution or MDHost, and MD and web service messages can be supported. Setting up the external MD or http connection can be covered under the above configuration.

In both cases, messages can be derived from a specific class, e.g., the clMemoryDefinitionBase class. Below is an example of a message class used to communicate with a RESTful web service:
MD Message

from dit_workflow.base import clMemoryDefinitionBase
class clUpdateDiQSavePreference( clMemoryDefinitionBase ):

MTinMB = False
http_messagetype = ‘user/savepreference’
http_format = ‘REST’
type = ‘user/savepreference’
def_{——}init_{——}(self,
username=‘’,
setname=‘’,
preferencename=‘’,
preferencevalue=‘’
):
Pass

Messages can be sent without a response, using e.g., sendMessage; however, if a response is desired, sendRequest can be used. Finally, if to guarantee the message, which means that a return ack is received, an aID=‘specificID’ can be included as a parameter of sendRequest.

sendRequest message
from dit_workflow.messagedistributor.pool import MDPool
   # first, we have to get the connection (comm adapter) we want to send the request to.
   # we get it by referencing the unique part of its section name
   1CommAdapter=MDPool.get(“Update”)
   # create our message. In this case, we're setting its fields when we create it
   1Message=clUpdateDiQSavePreference(username=getENV(_field_operator_id),
   setname=“Workflow_android”,preferencename=“ttsVolume”,preferencevalue=1NonExitWord)
   # sendRequest requires a message and the class type that we expect in return.
   aTimeoutInSeconds is optional but recommended
   1Response=1CommAdapter.sendRequest(1Message, clAccMessageResponse_DiQ,
   aTimeoutInSeconds=30)

As mentioned above, Exit words can be a list of one or more words in a dialog request that signal the workflow to do something, usually to process any data entered and go on to the next step in the workflow. Global and workflow words can be exit words that are available to most or all of the prompts in a workflow. These may be used to provide common functionality across a workflow. For example, the user might want to be able to exit the workflow from any dialog prompt. Using a global word, ‘exit workflow’ for instance, can provide that functionality without having to explicitly deal with it in each dialog request.

As shown in the example below, exit workflow can be added to the list of global words and two functions can be attached to it. The validate function, gblValidateExitWorkflow, may need to return True in order for the execute function to be executed. Here, the validate function can be just a stub routine returning False. If there is no validate function, it can be assumed to be True. The execute function, gblExecuteExitWorkflow, can be executed whenever ‘exit workflow’ is sent to the workflow and the validate function returns True.

System global words can be part of the Level 3 code, e.g., the Android® level, and provide the same system menu functionality that is available in vPack and voice artisan. Workflow global and workflow words can give the Level 4 programmer the ability to set up exit words that are available at any prompt without having to explicitly list them in each prompt. Instead, the words can be added to a special list and the grammar sections for them can be attached to all requests. When one of these words is entered, it can trigger a function attached to it, which may allow the workflow to have special functionality, like immediately exiting the current workflow, anywhere.

There may be various types of word definitions. For example, there can be five types of word definitions: System Global Words, Workflow Global Words, Workflow Words, Exit Local Words and Non-Exit Local Words. There can be more or less word definitions without departing from this disclosure.

System Global Words can include words that are defined by the Level 2 software, and can be made available by Level 2 via the “system” options, i.e., “system talk louder”. For vPack and voice artisan, system global words can be handled outside of the Level 3 code, e.g., Python® code/software, by various software packages/systems, such as Vocollect® software, and/or others, depending on the application and/or device. For Android® devices, system words can be handled in the Level 3 software. They are defined in the file dit_workflow/src/_platforms/android/util/system_menu.py. For example, for Android®, these words can be identified by the string: System_words.add(.

Workflow Global Words can include words that are defined for a Level 4 workflow.

These words can be defined for each Level 4 workflow in the file WorkflowGlobalWords.py located in the Level 4 workflow directory. The dialog functions in Level 3 can add this grammar section to the list of grammar sections to be enabled by Level 2.

Workflow Words can be defined by the specific workflow class. These words can be defined in a specified function, which can be called “addWorkflowWords( )”. The dialog functions in Level 3 can add this grammar section to the list of grammar sections to be enabled by Level 2. For example, workflow word can be identified by the string: aWords.add(.

Local (Exit and NonExit) Words can include the words that are added at the prompt and include exit and non-exit words. The local words can added by the request function, and can be, for example, identified by the requestX methods:
ASR_Alias.asr—is a key/value value that is used to define an alias for a specific word. For example; if we want the phrase “go go go” to be the same as “ready” then “go go go” would be added to this file.
ASR_Remove.asr—is a key field that is used to remove any words from the vocabulary.

With embodiments of this disclosure, System, Global or Workflow Words can be defined. All workflow words can be put into a special container, and each category of workflow word may have its own container. System global words can be in the a specified container, global workflow words can be in another specified container, while workflow words can be in yet another specified container, wherein it can be inherited by each workflow.

Words may be added to their container using the example add method, as shown in the example below:
Adding Global Workflow Words

from dit_workflow.base import global_words
def gblExecuteExitGame( ):

raise Exception(“PLEASE! EXIT THE GAME!”)

def addWorkflowGlobalWords( ):

global_words.add(‘exit game’,
aExecuteFunc=gblExecuteExitGame,
aValidateFunc=None,
aSkipPrompt=False,
aVerify=True,
aEcho=True)

The add method can have the parameters listed below:
aWord—the word being added to the container, this field is required. In the example, this is set to ‘exit game’.
aExecuteFunc—the function that is executed when this word is entered. This field is required.
aValidateFunc—the validate function that is checked when this word is entered. This field is optional and defaults to None.
aSkipPrompt—True/False, tells the dialog whether or not the last prompt should be repeated when we return from this function. This field is optional and defaults to False.
aVerify—True/False, tells the dialog whether or not we should ask the user to verify that they want to run the logic for this word. This field is optional and defaults to False.
aEcho—True/False, tells the dialog whether or not to echo the exit word. This field is optional and defaults to False.
aEnabled—True/False (not shown above), tells the dialog whether or not this word is active. If not, it will be ignored. This field is optional and defaults to False.

To define a system global word, in Android®, for example, system global words can be handled in the Level 3 workflow. The available system global words may be defined in the file dit_workflow/_platforms/android/util/system_menu.py, along with the validation and execution functions associated with them. They can be added in the function addGlobalSystemWords( ) which may automatically be called before the workflow application is started. It may not be recommended that any changes be made to system global words as there are other places in the Level 3 and Level 2 code that rely on them.

To define a workflow global word, for example, any given workflow application can have a module called “WorkflowGlobalWords.py” and a function in that module called “addWorkflowGlobalWords”. The function can be called automatically BEFORE the workflow application is started. The Level 4 programmer can be responsible for workflow global words.

To define a workflow word, for example, any given workflow class can have a function called “addWorkflowWords” which can override a stub method in clWorkflowBase. This function can be called automatically BEFORE the _init_ for your workflow object is called.

Local workflow words can also be defined and include those that are passed in the requestX functions. These include can the aNonExitWords and the aExitWords. An example showing workflow words and local words is shown below.

### Adding Workflow Words

class clGamesWorkflow( clWorkflowBase ):

#!###!#!###!#!###!#!###!#
# This area is to add the words to be used in any state in this
workflow.
#!###!#!###!#!###!#!###!#

def addWorkflowWords(self, aWords):

aWords.add(‘which game’,

aExecuteFunc=self.wflExecuteWhichGame,
aValidateFunc=self.wflValidateWhichGame,
aSkipPrompt=True,
aVerify=True,
aEcho=False)

aWords.add(‘what game’,

aExecuteFunc=self.wflExecuteWhichGame,
aValidateFunc=None,
aSkipPrompt=True,
aVerify=True,
aEcho=False)

#!###!#!###!#!###!#!###!#
# This function is to validate a single word to see if it is allowed
to be spoken.

def wflValidateWhichGame(self):
if not self.isCurrentState(self.stSelectGame) and not
self.isCurrentState(self.stWelcome):
return True
return False

# This function is to be executed IF the validate function returns

true or there is no validate function.

def wflExecuteWhichGame(self):
dialogs.nofityUser(“You are playing this game.”)
return False

#########################
## The Welcome State
#########################

def stWelcome(self):
#Setup stuff!
self[‘x’] = 1
self.x = 2
return self.setNextState(self.stSelectGame)

#########################
## The SelectGame State
#########################

def stSelectGame(self):

# here are some local words, both exit and non-exit

lNonExitWord, lExitWord, lIsScanned =
dialogs.requestWords(aToken=“Select Game: 1, 2, 3”,
aExitWords={“Ready”:“I”,“Quit”:“V”},
aNonExitWords=[‘1’,‘2’,‘3’])
return self.setNextState(self.stThisGame)

#########################
## The ThisGame State
#########################

def stThisGame(self):
lNonExitWord, lExitWord, lIsScanned =
dialogs.requestWords(aToken=“This Game: 1, 2, 3”,
aExitWords={“Ready”:“I”,“Quit”:“V”},
aNonExitWords=[‘1’,‘2’,‘3’],
aGrammarSection=“ConfirmSelectGame”)
if lNonExitWord[0] == ‘1’:
return self.setNextState(self.stWelcome)
return self.setNextState(None)

When a workflow word is spoken, the execution of the current prompt can be interrupted and passed to the validation function attached to the word, if any. If the validation function returns True, control may be passed to the execution function. The execution function can be as simple or complicated as needed, and can contain dialogs, calls to external systems or any other useful items. When the execution function finishes, it can return control to the dialog where it was initially called. FIG. 4B illustrates the flow of control for ‘exit game’, wherein L3 is Level 3, L4 is Level 4, and MD is Message Distributor.

In some situations, the user may not be allowed to use some category of workflow words. For example, this can automatically be done on a verify prompt, which can be kicked off when the user enters an exit word with the ‘V’ flag. Words can be disabled either individually or by group (system global, global workflow or workflow).

To disable or enable an individual word, the disable and enable method of the clWordsContainer class can be used. They take one argument, the word that you want to change the state of. The disabled word may still be part of the grammar section sent to the ASR engine, if one is active, but it will be ignored by the workflow when it is received.

### Disable Individual Word

# disables exit game in the workflow global words list
global_words.disable(‘exit game’)

To disable a category of workflow words for a particular prompt, one of the flags available may be set in the dialog functions. For system global words, the flag can be aDisableSystemWords; for workflow global the flag can be aDisableGlobalWords; and for workflow the flag can be a DisableWorkflowWords.

### Disable Word Category

lNonExitWord, lExitWord, lIsScanned =
dialogs.requestwordss(aTokenInstruction=tokWELCOME,

aTokenTemp=lTokenTemp,
aExitWords={“ready”:“”, “not ready”:“”},

# disable all categories
aDisableSystemWords=True,
aDisableGlobalWords=True,
aDisableWorkflowWords=True,

)

Grammar sections can be used to tell the ASR engine what words to listen for at this point in the workflow. When workflow performs a request from a user using one of the standard “request” methods, such as “requestDigits”, the request can include a grammar section. A grammar section may be a key that refers to a group of words that can be spoken by the user.

In workflow, the grammar sections can be dynamically generated by the parser based upon the main code, e.g., Python® scripts and the above mentioned files.

Three grammar sections can be enabled each time a requestX method is called, including Local Words, Global Words, and Workflow Words.

The local words may use two forms for grammar sections. The first may be the default form and is comprised of: <PythonClass>_<FunctionName>. The second form may be used when the requestX method defines a grammar section via the input parameters, and include: <PythonClass>_<FunctionName>_<GrammarName>. The second form may be used when two requestX methods are implemented in one state (function).

With embodiments of this disclosure, workflows can be constructed out of a series of states. States can be the way for the user to navigate through some specific task, with each state representing an element of that specific task, and as the user goes through the workflow, the current state can decide which state to send the user to next based on the input the user provides. For example, a Level 4 workflow generally can have a welcome or initial state, e.g., stWelcome state, where the workflow begins. From the stWelcome state, or any other state, the selected methods, e.g., setNextState and setRepeatState, can be used to navigate through the workflow. A brief example is shown below:
Workflow state example

def stWelcome(self, aArg=None):

if ‘Count’ not in global_cache:
global_cache[‘Count’] = 0
else:
global_cache[‘Count’] += 1
self[‘Count’] = global_cache[‘Count’]
# Lets add a temp token. If we got something passed in as aArg then lets use it.
lTokenTemp = None
if aArg:
# aParts can be a list if there are multiple replacements
# or a single item if there is only one replacement.
lTokenTemp = tokYOUSAID.setParts(aArg)
lNonExitWord, lExitWord, lIsScanned =

dialogs.requestwordss(aTokenInstruction=tokWELCOME,

aTokenTemp=lTokenTemp,
aExitWords={“ready”:“”, “not ready”:“”})
if lExitWord == “ready”:
dialogs.notifyUser(aTokenTemp=tokYOUSAID.setParts(“ready”))
else:
dialogs.notifyUser(aTokenTemp=tokITERATION.setParts(self[‘Count’]))
lMessage = clAccMessage_DiQ(username=“PDV21”, setname=“*”)
lCommAdapter = MDPool.get(‘DiQ’)
lResponse = lCommAdapter.sendRequest(lMessage, clAccMessageResponse_DiQ,

aTimeoutInSeconds=30)

dialogs.notifyUser(aTokenTemp=clTranslator.TOKEN(aTTS=“There are { }

permissions.”.format(len(lResponse.permissions))))

# If we didn't say ready then lets pass that into be used as our temp token.
return self.setRepeatState(aArg=lExitWord)
return self.setNextState(self.stReady)

def stReady(self):

dialogs.notifyUser(aTokenTemp=“In the ready, going to Welcome state”)
return self.setNextState(self.stWelcome)

In this example, there can be multiple sates, e.g., two, three or more states, stWelcome, which can be required, and stReady. The stWelcome state has an optional argument, aArg. The state can use two methods, setRepeatState, which can automatically go back to the current state, and setNextState, which can go to the named state, to navigate between each other.

All workflows classes can be derived from clWorkflowBase or from another workflow class. This base class may be designed to work as a state machine, which is an abstract machine that can be in one of a number of states. As the user navigates the workflow, control can be passed from one state to the other, based on the user's inputs.

In a workflow, states can be represented as methods. By convention, state methods may begin with ‘st’ to differentiate them from other methods in the workflow. Every workflow may have a stWelcome state, as this is the default starting point for a workflow.

States generally can have a similar structure. First, they may ask the user for some input. Then, based on the input, they may do some processing (send a message to an external system, echo the input, do some computation, etc.) and send the user to the next state based on the results. The next state may be the current one. To handle the mechanics of moving from state to state, the clWorkflowBase class can have a number of methods, examples of which are listed below.

clWorkflowBase State Methods
setNextState—used to send the workflow to another state, has one argument, aState, which is the name of the next state method. If aState is not set it defaults to None and the workflow exits.
setRepeatState—used to send the workflow back to the beginning of the current state, has no required arguments
getPreviousState—returns a reference to the previous state
getCurrentState—returns a reference to the state currently executing
getNextState—returns a reference to the state set as the next state to execute, if any
isPreviousState—has one required argument, aState, which it checks against the previous state reference to see if they're the same
isCurrentState—has one required argument, aState, which it checks against the current state reference to see if they're the same
isNextState—has one required argument, aState, which it checks against the next state reference to see if they're the same

### States Example

def stWelcome(self, aArg=None):

if ‘Count’ not in global_cache:
global_cache[‘Count’] = 0
else:
global_cache[‘Count’] += 1
self[‘Count’] = global_cache[‘Count’]
# Lets add a temp token. If we got something passed in as aArg then let's use it.
lTokenTemp = None
if aArg:
# aParts can be a list if there are multiple replacements
# or a single item if there is only one replacement.
lTokenTemp = tokYOUSAID.setParts(aArg)

lNonExitWord, lExitWord, lIsScanned =

dialogs.requestwords(aTokenInstruction=tokWELCOME,

aTokenTemp=lTokenTemp,
aExitWords={“ready”:“”, “not ready”:“”})
if lExitWord == “ready”:
dialogs.notifyUser(aTokenTemp=tokYOUSAID.setParts(“ready”))
else:
dialogs.notifyUser(aTokenTemp=tokITERATION.setParts(self[‘Count’]))
lMessage = clAccMessage_DiQ(username=“PDV21”, setname=“*”)
lCommAdapter = MDPool.get(‘DiQ’)
lResponse = lCommAdapter.sendRequest(lMessage, clAccMessageResponse_DiQ,

aTimeoutInSeconds=30)

dialogs.notifyUser(aTokenTemp=clTranslator.TOKEN(aTTS=“There are { }

permissions.”.format(len(lResponse.permissions))))

# If we didn't say ready then lets pass that into be used as our temp token.
return self.setRepeatState(aArg=lExitWord)
return self.setNextState(self.stReady)

def stReady(self):

dialogs.notifyUser(aTokenTemp=“In the ready, going to Welcome state”)
return self.setNextState(self.stWelcome)

The example above, taken from Workflow API, demonstrates the use of setRepeatState and setNextState. If setNextState has no arguments, the state defaults to None, which will cause the workflow to end.

In one exemplary embodiment, it may be possible to have nested workflow, for example, to start a workflow from inside another workflow or to start a workflow that is inside of a workflow within a workflow, and so on. By way of example, when the user exits the sub-workflow, they can return to the next one up the stack. In some cases, the workflow designer may want to move further up the stack and various methods are used to help with that. Exemplary methods include:

clWorkflowBase workflow methods
find—requires one argument, the workflow name you're looking for. returns a reference to the workflow if it is in the current workflow stack
getCurrentWorkflow—takes no arguments, returns a reference to the workflow currently executing
getRootWorkflow—takes no arguments, returns a reference to the workflow at the top of the stack
replaceWith—used to replace a workflow class reference linked to the class name with a different class reference linked to the same name

clWorkflowBase Exception Methods
raiseReturnTo—requires a workflow name, aWorkflowState is optional and defaults to stWelcome. This method will return execution to the named workflow and state
raiseEndWorkflow—a way to raise an exception that will cause the workflow to exit and return to its parent workflow, if any, or stop execution if no parent exists

Built into clWorkflowBase can be several methods that can make it easier to access other parts of the API, like messaging or logging. These will be described below.

Messaging examples:
sendMessage(self, args aAdapterName=None, *kwargs)—a wrapper used to send a message using the adapter named in the aAdapterName parameter, args are a list of arguments that are passed to the comma adapter's sendMessage function
sendRequest(self, args aAdapterName=None, *kwargs)—a wrapper used to send a request message using the adapter named in the aAdapterName parameter, args are a list of arguments that are passed to the comma adapter's sendRequest function

Logging functions can send a message to the logger. If the logging level is set equal to or higher than the logging function level, the message may be processed. Fatal is the lowest logging level, Trace the highest.
logTrace
logDebug
logInfo
logWarn
logError
logFatal

Workflows further can be customizable. For example, instead of creating an entirely new workflow, an existing work flow or sub-workflow can be sub-classed to provide customization for the methods required for a new workflow. To use a new workflow instead of the original, without changing the references in other source files, the replacewith method can be used. The replacewith method can change one class reference to another.

The global cache can be a convenient memory structure that may be referenced anywhere in the Level 4 workflow and used to store information across the main code/program modules, e.g., the Python® modules. To use the global cache, the global cache can be imported into the main code/program modules, e.g., the Python® module and used as a map (global[key]=value). For example, global[key], by itself, can retrieve the value. An example of the global cache may include:
global cache

from dit_workflow.base import global_cache
# set a value
global_cache[‘MyValue’] = 32
# retrieve a value
print(global_cache[‘MyValue’])

Various main codes, e.g., testing tools also can be used, for example tools that work in the Python® environment on Windows can be used to test a Level 4 workflow without having to put the workflow onto a specific device. Though there may be some limitations to this approach, for example, that it may be difficult or impossible to execute code for any platform, but win_ce, it is very effective at finding errors in level workflows.

In the base workflow class, clWorkflowBase, there can be a set of logging functions used to send logging messages at a variety of logging levels. These functions can be used anywhere in a workflow and each may handle a different logging level. For example, if LMS is configured in the workflow.ini, logging can be sent to the LMS server. The log functions may require one argument, a message. Example functions are listed below:
1. logTrace
2. logDebug
3. logInfo
4. logWarn
5. logError
6. logFatal

The specific logging statements that are sent can depend on the selected logging level set in the workflow.ini. In the list above, the example, functions are listed in order from most inclusive to least inclusive logging level. So, if the logging level were set to Fatal, only logFatal logging statements would be processed, while if the level were set to Trace, ALL logging statements would be processed.

### Example Workflow Operation/Task Performance

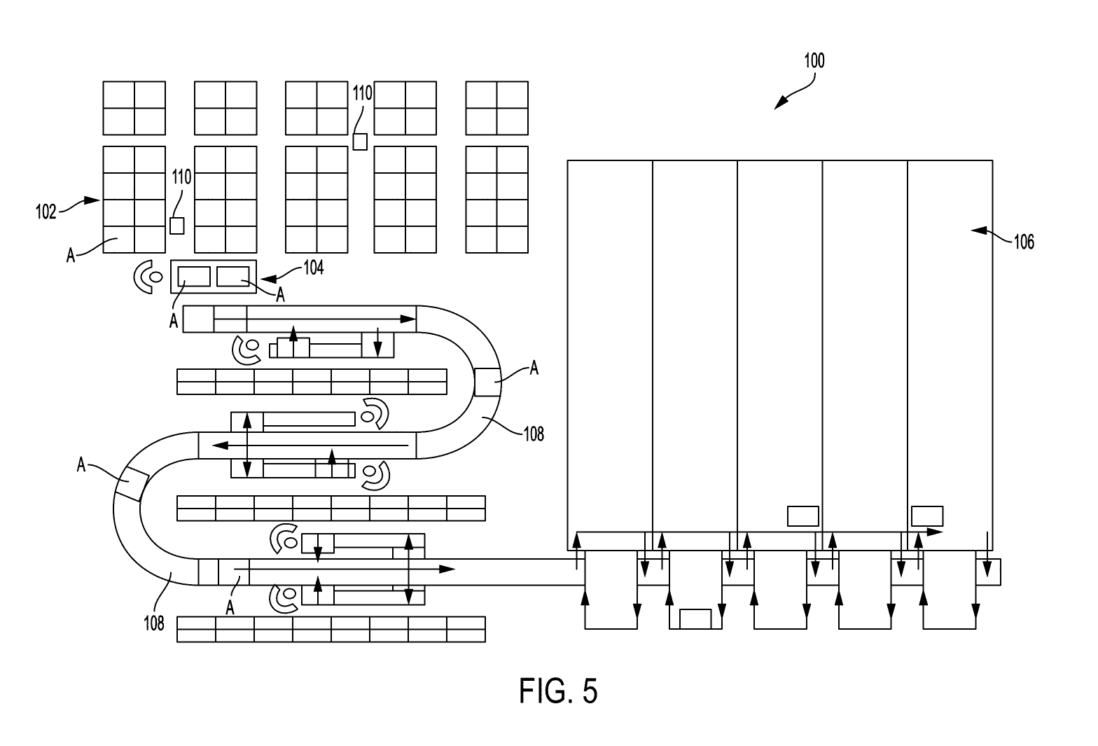

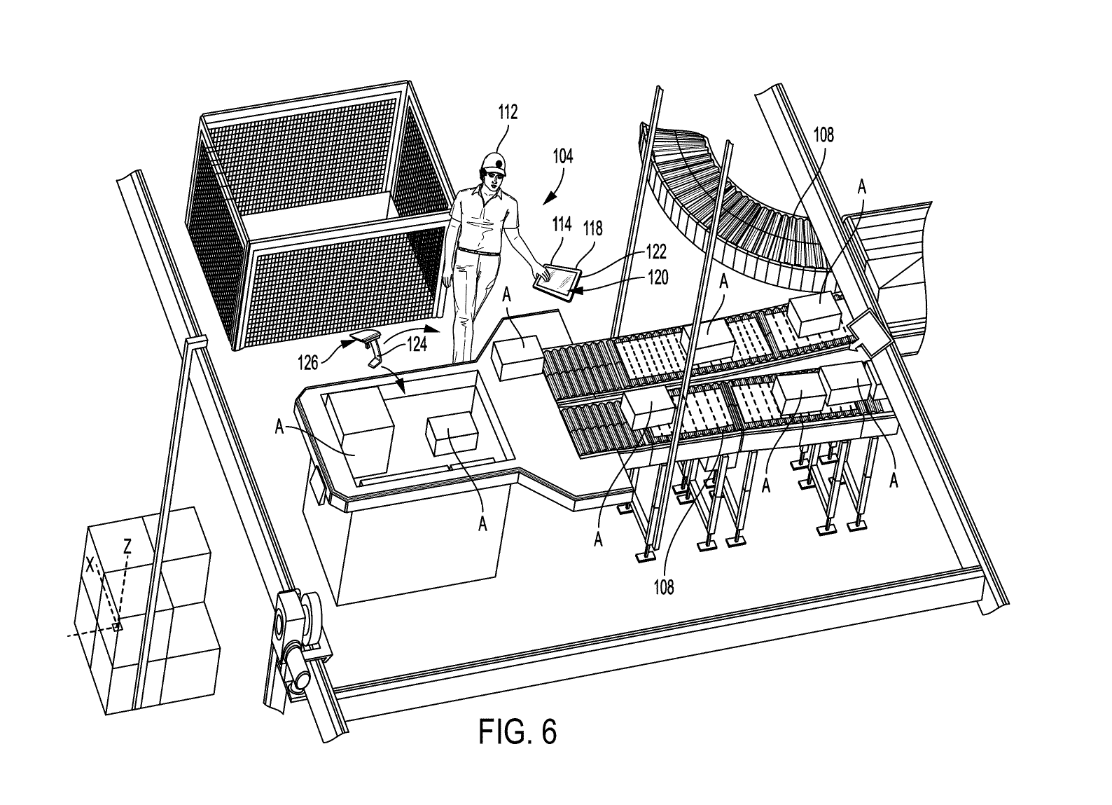

An example embodiment of the operation of the communications system 2 is shown in FIGS. 5-6 in use in a facility 100, such as an order fulfilling facility or warehouse for fulfilling orders for one or more articles or items A purchased from an online retailer. In general, various articles A may be located or stored in storage area(s)/location(s) 102, and when an order calling for one or more selected articles A is created, e.g., an order is placed by an online customer(s), the selected articles or items A can be transferred from their storage area(s) 102 to one of a series of picking stations 104 where the articles A can be sorted/picked and placed into/at a specific location, e.g., into a bin(s), for transfer to a packaging or shipment location 106, where the articles may be packaged and shipped to the customer(s).

To perform such a workflow operation or task, the business/facility operational workflow 14 (FIG. 1) generally can be designed with one or more task-lists or sub-workflows containing instructions and/or procedures (which can be particularized according to a plant's/customer's preferences or other parameters) for performing an overall task of order fulfillment. Such steps or instructions may require the use and/or cooperation of a variety of different automated monitoring, picking and conveying systems or devices. For example, a shuttle 116, such as a MultiShuttle® as provided by Dematic Corp., can be utilized to remove and collect selected articles or series of articles A from their storage locations 102 and then transfer the articles to one or more conveyors 108 for routing to a picking station 104 at which personnel or automated pickers 112 can utilize one or more automated systems or handheld or mobile devices 114, such as a tablet 118 with a display 120, a camera 122, a handheld scanner such as an IR or bar code scanner 124, or other devices to detect and confirm the correct article(s) has been received. The pickers can pick and place each article or series of articles required for fulfillment of each order assigned to that picking station into a bin or other conveyance, after which the bins can be conveyed to the packing station 106 for packing and shipment of the order to the customer. Using the communication system 2 according to the present disclosure, the communication, integration and operation of these various peripheral devices to perform such an order fulfillment workflow (or each sub-workflow/task assigned to/requiring each device) in a substantially seamless manner.

In one embodiment, a series of orders can be organized and assigned to be filled/completed by a selected station, zone, or cell of the facility by the workflow. Alternatively, groups or sets of orders created by the workflow can be posted for pickup by a next available cell, zone or device. For example, the engines of a shuttle 110, can communicate or send a query to the server or other storage media on which the facility workflow resides, indicating that that shuttle or device is free to take on a next order, and in response, the workflow can assign the shuttle a set or group of orders, each with a list of articles or items to be collected for the fulfillment of the order. Upon receipt of this assignment, the interface engine for the shuttle also can send a query to the facility server and to request and receive inventory location specific information for each of the articles or items on the order list provided by the workflow. Thereafter, the shuttle can perform its assigned task collecting each of the articles for fulfillment of the assigned orders from their particular inventory storage locations and transferring the collected articles to a sorting conveyor, or directly to a picking station.

Once its task is completed, the engine for the shuttle can report back to the server/workflow to confirm completion of its assigned task of collecting the items for the orders on its list has been completed and delivered to an assigned picking station. Thereafter, the workflow can send a query to the identified picking station, including instructions for personnel or automated pickers to sort and pick the items as needed to fill the orders. The workflow instructions can be sent to a tablet or laptop carried by the worker, or to a smaller device such as a mobile phone, or to a monitor mounted at the picking station. The communication system engine for each particular peripheral device (whether it be a laptop, tablet, monitor, etc.), will receive the assigned task or list of orders and will direct or instruct its associated device to perform tasks needed for fulfillment of each order, including identifying the specific articles or items required for each order (i.e., by a scanner or camera), and notifying the picker which article to pick and where to place them (e.g., by notification on their phone, tablet, etc.).

Once the worker or the picking station completes the steps of picking and sorting the articles into bins or packages for packaging and shipment for fulfillment of each of the customer orders assigned thereto in the workflow, the engine for the picking station or on the worker's tablet or other mobile device can in response to the worker scanning of each selected item for each order and/or their confirming the fulfillment of each order, send a response back to the workflow server indicating that fulfillment of each of the orders of the assigned list of orders has been completed. Thereafter, as the bins or packages containing each of the filled orders are conveyed to the shipment station, other devices such as scanners, cameras or optical character readers can monitor the progress and each of their engines can report the progress of such order bins or packages to shipment (via message compatible with the workflow platform language), as well as send a final confirmation that the orders have shipped, including providing a message to the facility server that links or identifies each order shipped with a particular ID or tracking number therefor.

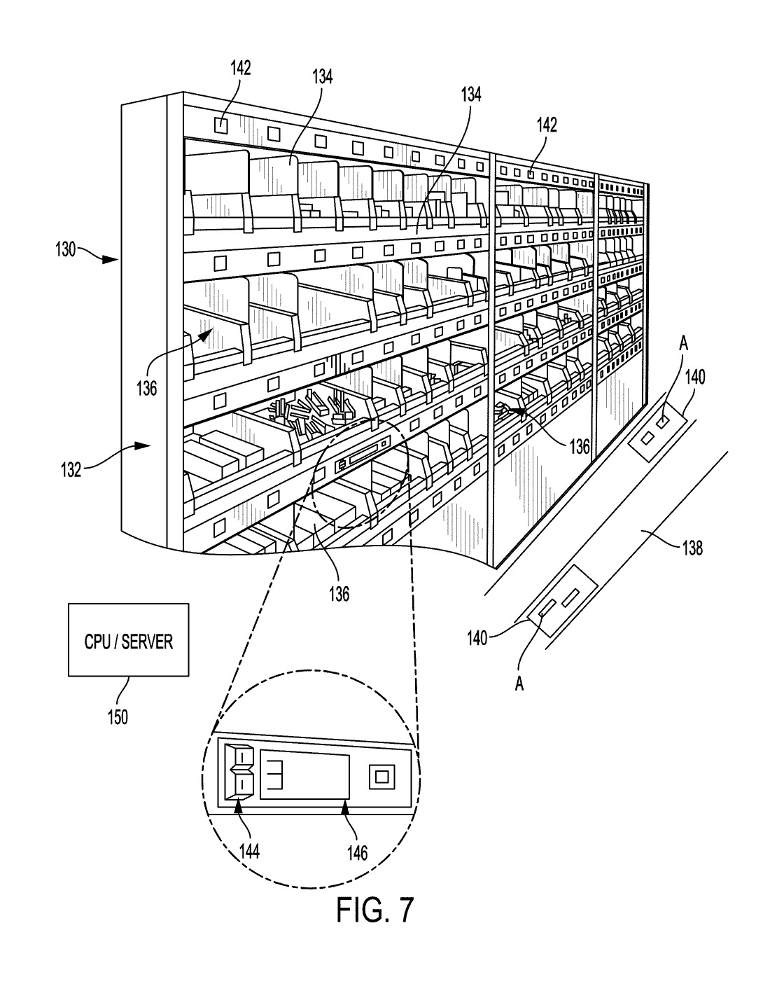

In an additional embodiment, the facility 100 can include a picking station, a loading station, or other stations 104 with one or more put-wall or pick-wall systems or assemblies 130 as generally shown in FIG. 7. The pick/put wall assemblies 130 may include, for example, a frame/structure 132 with a plurality of walls, barriers and/or shelving units 134 that at least partially define a plurality of partitioned areas or locations 136 that can be sized, dimensioned, or configured to receive one or more articles A. Pickers may place articles A into the partitioned areas 136, and after placement of the prescribed articles A into a specific area 136, e.g. articles fulfilling a specific order, these articles may be pulled from these partitioned areas to facilitate order fulfillment of the order. The operation and functions of the put/pick wall assembly 130 may be controlled by one or more put/pick wall workflows in communication with one or more workflow engines running on or otherwise accessed by a CPU or server, such as a desktop computer or server 150, and/or workflow engine running on or access by the mobile device 114 or scanner 142 in communication with the put/pick wall system 130. The desktop/server 150 use a predetermined/selected operating system, such as, e.g., Windows®, Apple®, or Linux® based operating systems, though any suitable operating system or platform is possible without departing from this disclosure. The mobile device 114 or scanner 142 may use an operating system that is distinct from each other and/or the operating system of the desktop, for example, Vocollect®, Windows®, Android®, or Apple® based operating systems, or other suitable operating systems without departing from this disclosure. The put/pick wall workflow(s) may be device neutral and contain business logic or instructions for carrying out the functions or operations of/at the pick/put wall system 130. The engines therefore can allow the desktop computer 150, the mobile device 114, and scanner 142 to access, communicate with, and/or run/execute the logic or instructions of the put/pick workflow(s), even though these devices may use distinct operating systems.

For example, articles A may be transported to and from the put/pick wall assembly 130 in bins or containers 140 using one or more conveyors 138 as shown in FIG. 7. However, articles A may also be transported to and from the put/pick wall assembly 130 using other means, such as MultiShuttle® as provided by Dematic Corp., without departing from this disclosure. Each article A can be associated with a specific inventory identifier, such as a stock-keeping unit (“SKU”), and each article A can bear an optical code, such as a bar code, radio frequency identification (“RFID”) tag, or QR code that is associated with the specific identifier of each article A. Pickers can remove the articles A from the bins or containers 140 and scan the optical code on each article A, for example, using the camera 122 of the mobile device or the scanner 124. Using the engines of this disclosure, the put/pick wall workflow can control or access the scanner 124 or camera 122 of the mobile device 114, and may also access the specific optical codes read thereby, and the put/pick wall workflow also may instruct or otherwise control the scanner 124 or the mobile device 114 to transmit or otherwise communicate the read/received optical code associated with and identifying the scanned item A to the desktop/server 150.

Upon receipt of this optical code identifying the scanned article A, the pick/put wall workflow may instruct or otherwise control the desktop/server 150 to communicate with the put wall system 130 to carry out functions that may instruct otherwise notify the picker of the specific area or location 136 to place the scanned article A. This may be done using pick-to-light principles. For example, each area or location 136 for receiving articles A may include a light source 142, such as an LED(s) or other suitable light source, and when the desktop 150 receives the optical code that is read/received by the scanner 124 or the camera 122 of the mobile device 114, the put/pick wall workflow may cause the desktop 150 to communicate with, or otherwise control, the put/pick wall system 130 to activate/illuminate at least one of the light sources 142 to and thereby indicate or notify the picker of the specific location or area 136 in which the scanned article A is to be placed. FIG. 7 shows that the light source(s) can be arranged along an outer surface of the structure 132 substantially adjacent to the specific area/location 136 associated therewith; however, the light source(s) may be positioned at least partially within its corresponding location or area 136 such that the area substantially illuminates to indicate to the picker where to activate or otherwise place the scanned item(s) A. After placement of the scanned item(s) A, the picker can activate one or more buttons 144, or icons displayed on a touch screen 146, arranged along the frame 132 to indicate to the put/pick wall workflow that the picker has placed the particular article A in the prescribed location 136. The put/pick wall workflow may then allow the scanner 124 or camera 122 of the mobile phone to read the optical code on another article A and repeat the above process.

When the workflow determines that certain articles A, e.g., currently available A articles for a specific order or each of the articles for the specific order, have been received in one or more of the prescribed locations/area 136, the put/pick wall workflow may instruct or other control the desktop 150 through the engine to communicate with, or otherwise control, the put/pick wall system 130 to illuminate the light source 144 corresponding to that location 136. A puller, the picker, or another picker, may thereafter place these articles A in one or more bins 140 for transport to the packing or shipping location(s) 106 for fulfillment of the order. In one example, the picker(s) placing the articles into areas 136 and the puller(s) taking the articles out of areas 136 may be positioned/located on opposing sides of the put/pick wall structure 132.

Since the put/pick wall workflow(s) can be device neutral, the mobile device 114, scanner 124 or other devices can be substituted or interchangeably used to access or communicate with the put/pick wall workflow(s) using their respective engines, and thus the various operations and functions of, or performed at, the put/pick wall system 130 can be controlled by anyone of the desktop 150, mobile device 114, scanner 124, or other suitable devices, even though such devices may use different operating systems. For example, the put/pick wall workflow may be accessed by the engine of the mobile device 114 to allow a user to control the operations and functions of the put/pick wall system 130, such as to illuminate the light sources 144 upon scanning of each of the article's A associated optical codes or reset the scanning functions of the scanner or mobile device when the picker activates buttons 144 or touchscreen 146, using the mobile device 114. Accordingly, various devices which may operate on distinct platforms or operating systems can be interchangeably implemented to perform various aspects of the put/pick wall workflow(s) to control or execute the various functions/operations at the pick/put wall assemblies 130.

Accordingly, with the communication system 2 according to the principles of the present disclosure a facility workflow can simply be defined to provide somewhat standardized, device neutral instructions or procedures for facility operations such as fulfillment or orders, including on an order by order basis. The communication system engines for each of the different peripheral devices instead can be configured to operate to collect and interpret the workflow task instructions for performance thereof by each of their associated peripheral devices. Thus, workers can use different types of tablets, mobile phones, scanners or other peripheral devices, in addition to working with automated systems as a Dematic Multishuttle® or the like, to perform each task step or procedure required assigned by or retrieved from the workflow. All that the workflow needs to be concerned with is providing its requests for fulfillment of a series of orders (which also can include desired or prescribed procedures therefor) and once a task or subwork flow operation has been assigned or accepted (i.e., by a station, zone, or series of devices in a facility), the engines for each of the peripheral devices linked or included within the communication system 2 can operate independently to complete the tasks, the facility workflow simply can receive a confirmation of completion of the assigned task, without being required to actively control the operation of each individual or specific peripheral device.

The communication system according to principles of the present invention thus enables a device neutral or device independent work flow to be designed, created and programmed into a facility or server or other storage media (i.e., including data stored on the cloud so as to be accessible remotely or across multiple facilities), and which workflow does not have to be programmed in any specific programming language or utilize a specific operating platform such as Windows®, Apple iOS® or Android®. Rather, the engines of the communication system are designed to interface with each of the plurality of different operating platforms or software/programming languages utilized by or can be utilized by various automated systems and/or handheld computing devices and interpret or translate and direct the workflow instructions for their associated devices. This enables changes or modifications to the facility or business work flow to be made substantially without regard to a particular operating platform or programming language used by one or more of the programming devices used in a facility or plant; and further enables customers to not only utilize different devices and technologies, they further can upgrade their technology equipment in a manner that generally will be more cost effective. For example, workers can utilize any of a variety of different handheld devices such as tablets, laptops, phones, etc., that each utilize an operating system such as windows, iOS® or Android®, based on preference or ease of use/familiarity, and in addition, as older peripheral devices such as scanners, cameras, barcode readers or other similar devices, either become obsolete, not supported by their vendors, or as newer technologies become available, these devices can be modified, upgraded and replaced (including replacement of selected or discrete units) with newer technologies or devices in a generally more seamless manner since a new, device specific work flow does not have to be created, rather the engine operable with such device may simply need to be updated as required.

The foregoing description generally illustrates and describes various embodiments and examples of this disclosure. It will, however, be understood by those skilled in the art that various changes and modifications can be made to the above-discussed constructions and systems without departing from the spirit and scope of this disclosure as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further can be made thereto without departing from the spirit and scope of the present invention as set forth in the appended claims.

What is claimed is:

1. A method for enabling and controlling communications between different devices for execution of one or more tasks, functions, and/or operations at a facility, comprising:
receiving identification information from one or more of the devices, at least some of the devices utilizing distinct software programs or operating platforms;
retrieving one or more device-neutral workflows associated with the received device identification information;
transmitting the one or more workflows to the one or more devices, each of the one or more workflows being received by an engine loaded on or accessed by a device receiving the workflow;
retrieving and translating a set of logic or operating instructions in the device-neutral workflows retrieved by the device with the engine thereof such that the set of logic or operating instructions are operable by the distinct operating platform or software of the device receiving the workflow, the set of instructions configured for controlling execution of selected task, function, and/or operation;
accessing one or more components and/or resources of the device to instruct the one or more components or resources to instruct the device to perform the one or more tasks, functions, and/or operations at the facility using the translated set of instructions.

2. The method of claim 1, wherein the devices comprise software platforms or operating systems including Windows®, Apple®, Android®, Linux®, or Vocollect® platforms or operating systems, or combinations thereof.

3. The method of claim 1, wherein the devices further comprise an operating system including a Universal Windows Platform.

4. The method of claim 1, wherein the devices include servers, desktops, controllers, tablets, mobile phones, scanners, and/or combinations thereof.

5. The method of claim 1, wherein the set of instructions of each device-neutral workflow comprise instructions for analyzing quality of the tasks, functions, or operations performed at the facility and/or allowing one or more users or facility personnel to evaluate quality of the tasks, operation, or functions of the facility using at least one device of the devices.

6. The method of claim 1, further comprising:
managing device resources and/or device-specific components of the devices using a first component of the engine of the device including device-dependent or device-specific instructions;
initiating communication with a third component of the engine using a device-specific executable logic component of the engine; and
loading and running the one or more device-neutral workflows on the devices using the third component of the one or more engines.

7. The method of claim 1, wherein the facility comprises an order fulfillment facility or warehouse for fulfillment of product orders.

8. The method of claim 1, further comprising substantially interchangeably controlling and executing one or more tasks, functions, or operations a picking of a plurality of picking stations at an order fulfillment facility or warehouse using multiple devices of the devices.

9. A communication and control system for enabling and controlling communications for execution of one or more tasks, functions, and/or operations within a facility, the system comprising:
a plurality of differing devices, each comprising a processor, and wherein one or more of the devices utilize disparate operating systems and/or software programs; and
a series of engines, each resident on or accessed by the processor of a corresponding device of the plurality of devices;
wherein the series of engines are operable to access one or more device-neutral workflows received by their corresponding devices, each of the device-neutral workflows comprising a set of instructions for directing performance of a selected one or more of the tasks, functions, and/or operations to be performed at the facility, and
wherein the series of engines translate and communicate the set of instructions of the received device-neutral workflows to the processor and/or one or more additional components of their corresponding devices to initiate and cause their corresponding devices to carry out the set of instructions thereon and enable the plurality of devices to perform or execute the selected tasks, functions, and/or operations.

10. The system of claim 9, wherein the facility comprises an order fulfilling facility or warehouse operable to fulfill ordered articles of a plurality of purchases.

11. The system of claim 10, wherein the order fulfilling facility or warehouse comprises a series of stations, zones or cells wherein the plurality of devices includes a handheld device and controller each operating or running disparate software platforms or operating systems, and wherein the set of instructions includes instructions or logic for carrying out one or more tasks, functions, and/or operations at selected ones of the stations, zones or cells, and wherein one or more engines of the series of engines translate and communicate the set of instructions to the handheld device and the controller to allow the handheld device and the controller to substantially interchangeably control and execute the one or more tasks, functions, or operations at selected ones of the stations, zones or cells.

12. The system of claim 11, wherein the stations, zones or cells include picking stations, storage areas, and/or loading stations.

13. The system of claim 9, wherein the plurality of devices further include at least one put-wall or pick-wall system including a plurality of sections that at least partially define partitioned areas sized, dimensioned, and/or configured to receive one or more of the ordered articles, and wherein the set of instructions includes instructions for executing or carrying out one or more tasks, functions, and/or operations of at least one put-wall or pick-wall system, and wherein in response to a determination that prescribed articles of the ordered articles have been received in one or more of the partitioned areas, and wherein the set of instructions are communicated through one or more engines to the put-wall or pick-wall systems, the controller, and/or the handheld device to instruct picking and/or placement of the prescribed articles onto one or more conveying systems, shuttles, containers, and/or bins to be transported for order fulfillment.

14. The system of claim 9, wherein each engine of the series of engines includes a first component having device-dependent or device-specific instructions operable to manage its corresponding device's resources and/or device-specific components; and a second component that having device-specific executable logic operable to start or initiate and communicate with a third component that loads and runs the one or more device neutral workflow on its corresponding device.

15. The system of claim 9, wherein the disparate platforms of the devices or operating systems include Windows®, Apple®, Android®, Linux®, or Vocollect® platforms or operating systems, or combinations thereof.

16. The system of claim 9, wherein the disparate platforms or operating system of the devices comprise a Universal Windows Platform.

17. The system of claim 9, wherein the at least one workflow facilitates analysis of quality of the tasks, functions, or operations performed at the facility and/or allow users or facility personnel to evaluate quality of tasks, functions, or operations performed at the facility.

18. The system of claim 9, wherein the plurality of devices includes servers, desktops, controllers, tablets, mobile phones, scanners, and/or combinations thereof.
